(19) United States
(12) Patent Application Publication
(10) Pub. No.: US 2016/0182977 A1
(43) Pub. Date: Jun. 23, 2016

(54) USER INTERACTION WITH ADVERTISEMENTS ON HYBRID TERMINALS

(71) Applicant: TELEFONAKTIEBOLAGET L M ERICSSON (PUBL), Stockholm (SE)

(72) Inventors: Nilo Mitra, New York, NY (US); Paul Higgs, Roswell, GA (US)

(21) Appl. No.: 14/577,359

(22) Filed: Dec. 19, 2014

(51) Int. Cl. H04N 21/858; H04N 21/81; H04N 21/431; H04N 21/475; H04N 21/25; H04N 21/258; H04N 21/8545; H04N 21/442

(52) U.S. Cl. CPC H04N 21/8586; H04N 21/8545; H04N 21/812; H04N 21/44222; H04N 21/4756; H04N 21/4755; H04N 21/251; H04N 21/25891; H04N 21/4316; H04N 21/4318

(57) ABSTRACT

A system and method that enables a user to interact with an advertisement and express an opinion about it. Such user interactivity is provided through a Hybrid Broadcast Broadband TV, HbbTV, auto-start application, which is associated with an advertisement event and a Uniform Resource Locator, URL, to the auto-start application is carried in a Digital Video Broadcast Application Information Table, DVB AIT, of the broadcast transport stream associated with the TV program or channel where the advertisement is to be shown. The hybrid terminal receiving the AIT-containing transport stream retrieves the auto-start application using the URL before the corresponding ad is played back to the viewer. When the ad is played, the retrieved application is simultaneously launched. The application's UI allows the user to interact with the ad or express an opinion about the content of the ad. A user's interaction with an advertisement can be tracked as well.

### TECHNICAL FIELD

The present disclosure generally relates to displaying advertisements on a hybrid terminal such as, for example, a smart television (TV). More particularly, and not by way of limitation, particular embodiments of the present disclosure are directed to a system and method in which a transport stream from a television broadcast network provides the means by which an end user, having received an interactivity-enabled advertisement on the user's hybrid terminal, can interact with the advertisement and express an opinion about it.

### BACKGROUND

Hybrid terminals are now widely available worldwide in many form factors such as, for example, Set-Top Boxes (STBs), smart TVs, digital media players, Blu-ray players, video game consoles, digital hotel television systems, and so on. Hybrid terminals not only provide conventional broadcast television functionality, but also have integrated Internet and web access features such as, for example, access to the world wide web (www) portion of the Internet. Thus, hybrid terminals are examples of technological convergence between computers and television sets/STBs and, hence, also include network-connected interactive devices that utilize television type display outputs. The software that runs a hybrid terminal may be pre-loaded onto the device, or updated or installed on-demand via an online application store (app store) or app marketplace, in a manner similar to what is done for modern smartphones.

FIG. 1 illustrates a system 15 showing a hybrid terminal 17 connected to a television broadcast network 19 and a broadband network 20. Some examples of the hybrid terminal 17 are provided in the preceding paragraph. For the purpose of the present disclosure, each of the networks 19-20 is considered to be a fully digital network. The hybrid terminal 17 may support playback of conventional broadcast television content through its connection to the broadcast network 19 such as, for example, a terrestrial broadcast TV network, a cable TV network, or a satellite TV network. Besides the traditional functions of television sets and STBs, the hybrid terminals 17 can also support delivery of online interactive media, Internet TV, Over-the-Top (OTT) content, as well as on-demand streaming media through its connection to the broadband network 20. The broadband network 20 may be an Internet Protocol (IP) based network such as, for example, a private IP network owned by a cable or telco provider or the publicly-accessible Internet. The hybrid terminal 17 may provide home networking access to record videos on a hybrid terminal-based local storage drive (not shown in FIG. 1) and may also allow viewers to search, find and play videos, movies, photos, and other content from the Internet through the broadband channel, or through an electronic program guide (EPG) offered by a cable TV provider or a satellite TV provider, or an over-the-air TV broadcast network.

Thus, the hybrid terminal 17 supports a model where broadcasted live (or linear) TV content is consumed through a digital broadcast connection supplemented with a digital broadband connection to the Internet. The digital broadcast connection may be, for example, an Advanced Television Systems Committee (ATSC), Digital Video Broadcasting (DVB), or Integrated Services Digital Broadcast (ISDB) based broadcast connection provided by terrestrial, cable, or satellite access based broadcast network 19. The digital broadband connection or “channel” may allow the hybrid terminal 17 to access additional audio-visual (A/V) content that can be downloaded or streamed to the hybrid terminal, as well as a signaling path to back-end servers (not shown in FIG. 1)—in the broadcast network 19 and/or the broadband network 20—to retrieve additional information to enhance the broadcast experience for the viewer.

The hybrid terminal 17 may be a Hybrid Broadcast Broadband TV (HbbTV) terminal that supports the broadcast and broadband delivery of entertainment to the end consumer. An HbbTV terminal provides a single user interface for delivery of digital broadcast TV and broadband TV to the consumer. The HbbTV terminal can operate over different digital broadcasting technologies such as terrestrial, cable, or satellite broadcasts.

There is a lot of industry interest in providing advertisements (also referred to herein as “Ads” or “ads”) that are personalized to the user. The ads may be selected based on various service provider analytics data and other algorithms.

An industry standard that describes how an interactive application can be signaled on the broadcast channel via a Digital Video Broadcast (DVB) Service Information (SI) table—known as the Application Information Table (AIT)—is the European Telecommunications Standards Institute (ETSI) Technical Specification document 102 809, version 1.1.1, titled “Digital Video Broadcasting (DVB); Signalling and carriage of interactive applications and services in hybrid broadcast/broadband environments” (2010 January), available at www.etsi.org; the relevant disclosure of this document is incorporated herein by reference in its entirety. Various DVB SI tables are described in the ETSI European Standard (EN) document ETSI EN 300 468, version 1.14.1, titled “Digital Video Broadcasting (DVB); Specifications for Service Information (SI) in DVB systems” (2014 May), available at www.etsi.org; the relevant disclosure of this document is incorporated herein by reference in its entirety. On the other hand, the Hybrid Broadcast Broadband Association addresses how a hybrid terminal can interact with the broadcast Service Provider (SP) on the broadband channel. A standard that describes such interaction is the ETSI Technical Specification document 102 796, version 1.2.1, titled “Hybrid Broadcast Broadband TV” (2012 November), the relevant disclosure of this document is incorporated herein by reference in its entirety. Furthermore, the standard that describes how interactive video content can be displayed as a browser window on a Smart TV is defined by the OIPF's Declarative Application Environment (DAE) specification, titled “Volume 5: Declarative Application Environment” (2014 Jan. 24), Release 2, Version 2.3, available at www.oipf.tv; the relevant disclosure of this document is incorporated herein by reference in its entirety. Here, the acronym “OIPF” refers to Open IPTV Forum, and the acronym “IPTV” refers to Internet Protocol (IP) TV. Almost all Smart TVs manufactured worldwide now support this HbbTV/OIPF interactivity solution, with the interactivity feature being activated based on market deployments.

### SUMMARY

Current industry solutions for delivery of interactive video content rely on the presence of a Set-Top Box (STB), which contains all the programming logic to support the processing of such video content. The STB is generally connected to a TV display via High Definition Multimedia Interface (HDMI).

However, hybrid terminals or smart TVs are typically directly connected to broadcast network, and absorb most of the functions normally provided in the STB. The smart TVs choose to provide the video display via a browser window, resulting in the so-called “thin client” model. On the other hand, STBs are available with the same HbbTV functionality as offered in Smart TVs for use as a front end to legacy TVs.

Existing industry solutions fail to address certain interactivity related aspects for broadcasted advertisements displayed on hybrid terminals. More specifically, current industry solutions fail to specify the means by which an end user who receives an interactivity-enabled ad on his/her smart TV can express an opinion about the ad through interaction with the ad. Such opinion can include, for example, “liking” the ad, wishing for more ads of the same genre, requesting a long form video related to the ad content, ordering the product being advertised through the ad, and the like.

It is therefore desirable to devise a solution that enables an end user to fully interact with a broadcast ad currently being displayed/played on the end user's hybrid terminal or smart TV.

The present disclosure offers a solution to the above-mentioned problem of lack of full interactivity with advertisements delivered by a television broadcast network to hybrid terminals. Particular embodiments of the present disclosure describe how the end user, having received an ad for which interactivity is enabled, can interact with that ad, for example, by “liking” it or expressing an opinion on it or interacting with it in some other ways. The teachings of particular embodiments of the present disclosure take advantage of the back channel IP connection available in hybrid terminals based on the interactivity provided by browser-based applications defined by the OIPF/HbbTV specifications.

In particular embodiments of the present disclosure, an HbbTV auto-start (or self-executing) application is associated with an advertisement event/slot and a link to the auto-start application is carried in a DVB AIT table of the broadcast/multicast transport stream (TS) associated with the TV program channel on which the advertisement is to be shown. In one embodiment, the link in the AIT may be to the broadcast TV service provider's (SP) Ad Decision Server (ADS). The ADS may be configured to return the appropriate application associated with the particular ad chosen for that slot. In certain embodiments, ads personalized for the viewer may be provided by the service provider for available advertising slots. In the case of a non-personalized ad or a general ad, such as, for example, a national, regional, or local ad, the link in the DVB AIT table may be a link to the location/source where the ad-related auto-start application is placed by the advertiser.

The hybrid terminal receiving the AIT-containing transport stream may retrieve the auto-start application—from the SP's ADS or other appropriate source—before the corresponding ad is played back to the viewer. When the ad is played, the retrieved application is simultaneously launched. In particular embodiments, this application's User Interface (UI) may cause a semi-transparent overlay over a portion of the ad video or show a small banner in the bottom of the terminal's screen while the ad is playing. In either case, a message may be displayed to the user allowing the user to express an opinion about the content of the ad using some keys on the user's remote control.

In the case of SP-inserted advertising, in one embodiment, the user's response may be sent back to an ad tracking server of the service provider for further processing. On the other hand, in case of the non-replaced/generic national, regional, or local advertising, the user's response may be sent back to the advertiser for further processing.

It is noted here at the outset that, for ease of discussion, the term “broadcast” is primarily used throughout the discussion herein and only broadcast network-based embodiments are illustrated. However, it is understood that the teachings of the present disclosure equally apply, with suitable modifications (if needed), to television content delivery through multicast over a broadband network. Hence, depending on the context of discussion, the term “broadcast”—as applied to the teachings of the present disclosure—may also refer to the television programming delivered through multicast.

In one embodiment, the present disclosure is directed to a method of enabling a user to interact with an advertisement being played on a hybrid terminal associated with the user. The hybrid terminal is coupled to a television broadcast network that delivers the advertisement to the hybrid terminal. The method comprises performing the following: (i) the television broadcast network receiving broadcast content containing television programming; (ii) the television broadcast network creating a transport stream of the broadcast content; (iii) the television broadcast network preparing a table associated with an ad slot containing the advertisement within the transport stream; (iv) the television broadcast network placing an ad application Uniform Resource Locator (URL) in the table; and (v) the television broadcast network delivering the transport stream containing the table with the ad application URL to the hybrid terminal. In the method, the ad application URL identifies an ad application that is hosted on an ad application server. The ad application, when launched by the hybrid terminal, enables the user to interact with the advertisement.

In one embodiment, the transport stream is a Motion Picture Experts Group 2 (MPEG2) Transport Stream (TS), and the table is a Digital Video Broadcast (DVB) Service Information (SI) Application Information Table (AIT).

In another embodiment, the method further comprises: (i) the ad application server receiving a request for the ad application from the hybrid terminal; and (ii) the ad application server sending a result to the hybrid terminal, wherein the result includes the ad application along with a response URL identifying a tracking server that receives information about the user's interaction with the advertisement. The result may further include an identifier identifying the advertisement and/or metadata associated with the advertisement.

In another embodiment, the ad application server identified in the ad application URL may operate as either (i) a forwarding proxy or (ii) a redirect proxy.

In one embodiment, the ad application, when launched by the hybrid terminal, may cause the hybrid terminal to display a user interface overlaid with a specified degree of transparency on a portion of the advertisement and offering one or more choices selectable by the user to enable the user to interact with the advertisement. The hybrid terminal may remove the displayed user interface if the user fails to interact with the advertisement within a pre-determined time period.

In another embodiment, the present disclosure is directed to a method of enabling a user to interact with an advertisement being played on a hybrid terminal associated with the user. The hybrid terminal is coupled to a television broadcast network that delivers the advertisement to the hybrid terminal. The method comprises performing the following by the hybrid terminal: (i) receiving a transport stream from the television broadcast network containing the advertisement, wherein the transport stream contains a table associated with an ad slot containing the advertisement within the transport stream, and wherein the table includes an ad application URL that identifies an ad application that is hosted on an ad application server; (ii) processing content of the table to obtain the ad application URL; (iii) based on the ad application URL, sending a request to the ad application server; (iv) receiving a result from the ad application server, wherein the result includes the ad application along with a response URL identifying a tracking server that receives information about the user's interaction with the advertisement; and (v) playing the advertisement and launching the ad application, whereby, through the launching of the ad application, the hybrid terminal is operative to enable the user to interact with the advertisement. In the method, the result from the ad application server may further include an identifier identifying the advertisement, and/or metadata associated with the advertisement.

In one embodiment, the hybrid terminal may perform one of the following as a result of the launching of the ad application: (i) record a choice selected by the user through the user interface and report information about the user-selected choice to the tracking server using the response URL; or (ii) using the response URL, report to the tracking server that the user has failed to interact with the advertisement within a pre-determined time period.

In another embodiment, the hybrid terminal may further perform the following: (i) receive an AIT termination message from the television broadcast network; and (ii) terminate the launched ad application in response to the AIT termination message.

In a further embodiment, the present disclosure is directed to a television broadcast network for enabling a user to interact with an advertisement being played on a hybrid terminal associated with the user. The hybrid terminal is coupled to the television broadcast network that delivers the advertisement to the hybrid terminal. The television broadcast network comprises: (i) a video processing system that receives broadcast content containing television programming and generates an MPEG2 Elementary Stream (ES) of the broadcast content; and (ii) a headend coupled to the video processing system and the hybrid terminal. In the television broadcast network, the headend is operative to: (i) create an MPEG2 TS from the MPEG2 ES of the broadcast content, (ii) prepare a DVB SI AIT associated with an ad slot containing the advertisement within the MPEG2 TS, (iii) place an ad application URL in the DVB SI AIT, wherein the ad application URL identifies an ad application that is hosted on an application server, and wherein the ad application, when launched by the hybrid terminal, enables the user to interact with the advertisement, and (iv) deliver the MPEG2 TS containing the DVB SI AIT with the ad application URL to the hybrid terminal.

In yet another embodiment, the present disclosure is directed to a hybrid terminal for enabling a user to interact with an advertisement being played on the hybrid terminal. The hybrid terminal is coupled to a television broadcast network that delivers the advertisement to the hybrid terminal. The hybrid terminal comprises: (i) a display unit for displaying the advertisement to the user; (ii) a memory for storing program instructions; (iii) a network interface for receiving broadcast and broadband content; and (iv) a processor coupled to the memory, the display unit, and the network interface. The network interface includes a broadcast television interface to receive broadcast television programming, and a broadband interface to interact with broadcast television network servers, retrieve multicast television programming or receive advertisements for subsequent insertion. The processor is configured to execute the program instructions. Upon execution of the program instructions by the processor, the hybrid terminal is operative to receive an MPEG2 TS containing the advertisement from the television broadcast network, wherein the MPEG2 TS contains a DVB SI AIT associated with an ad slot containing the advertisement within the MPEG2 TS, and wherein the DVB SI AIT includes an ad application URL that identifies an ad application that is hosted on an application server. The hybrid terminal is further operative to: (a) process the DVB SI AIT to obtain the ad application URL; (b) based on the ad application URL, send a request to the application server via a broadband Internet Protocol (IP) connection; (c) receive a result from the application server, wherein the result includes the ad application; (d) play the advertisement on the display unit; (e) launch the ad application; and (f) in response to launching the ad application, display a user interface on the display unit overlaid with a specified degree of transparency on a portion of the advertisement, wherein the user interface includes one or more choices to enable the user to interact with the advertisement.

In one embodiment, upon execution of the program instructions by the processor, the hybrid terminal is further operative to record a choice selected by the user through the user interface and report information about the user-selected choice to a tracking server using the tracking server's URL received as part of the result from the application server. The hybrid terminal may instead use the response URL to report to the tracking server that the user has failed to interact with the advertisement within a pre-determined time period.

The present disclosure thus enables a user to interact with a broadcasted advertisement and express an opinion about it. The present disclosure also provides for the tracking of a user's interaction with an advertisement. In the case where the displayed ad is a generic/non-personalized ad placed at a national, regional, or local level, the user interactivity as defined by the present disclosure can help the advertiser gain better feedback for ad placements than what is currently available. In the case where the ad placement is personalized to a user, the service provider can gain confirmation on the accuracy of the analytics results which led to the ad selection for that user. The present disclosure also allows an indication of audience measurement. When the Smart TV receives the AIT carrying the URL to the interactive application, it fetches the application from the URL. Since the Smart TV responded to a signal in the TS, it indicates that it was tuned to the channel at that time.

### BRIEF DESCRIPTION OF THE DRAWINGS

In the following section, the present disclosure will be described with reference to exemplary embodiments illustrated in the figures, in which:

FIG. 1 illustrates a system showing a hybrid terminal connected to a television broadcast network and a broadband network;

FIG. 2A is an exemplary flowchart depicting various steps that may be performed by a television broadcast network according to one embodiment of the present disclosure;

FIG. 2B is an exemplary flowchart depicting various steps that may be performed by a hybrid terminal according to one embodiment of the present disclosure;

FIG. 3 illustrates exemplary details of a broadcast system for enabling user interaction with an advertisement according to one embodiment of the present disclosure;

FIG. 4 shows an exemplary signaling flow for user interaction with national or regional ads according to one embodiment of the present disclosure;

FIGS. 5A-5B illustrate how AITs may be sent via an MPEG2 TS according to particular embodiments of the present disclosure;

FIGS. 6A-6B illustrate two exemplary user interfaces (UIs) that may be displayed to a user when corresponding ad apps are launched by a hybrid terminal according to particular embodiments of the present disclosure;

FIG. 7 shows exemplary details of a broadcast system for delivering personalized ads and for enabling user interaction with such ads according to one embodiment of the present disclosure;

FIG. 8 depicts an exemplary signaling flow for user interaction with SP-personalized ads according to one embodiment of the present disclosure; and

FIG. 9 is a block diagram of an exemplary hybrid terminal according to one embodiment of the present disclosure.

### DETAILED DESCRIPTION

In the following detailed description, numerous specific details are set forth in order to provide a thorough understanding of the present disclosure. However, it will be understood by those skilled in the art that the teachings of the present disclosure may be practiced without these specific details. In other instances, well-known methods, procedures, components and circuits have not been described in detail so as not to obscure the present disclosure. Additionally, it should be understood that although present disclosure is described primarily in the context of television programming delivered through a broadcast network, the disclosure can be implemented for any other type of audio-visual content such as, for example, movies, non-television video programming or shows, and the like, and also for multicast delivered content.

Furthermore, the terms like “user terminal,” “client terminal,” “subscriber terminal,” and “hybrid terminal” may be used interchangeably herein to refer to a hybrid terminal—in any form factor—that supports connections to a broadcast/multicast network and a broadband network. The connection to the broadcast network allows the hybrid terminal to receive the broadcasted content and signals through a transport stream, and the connection to the broadband network provides a “back channel” that allows the hybrid terminals to communicate with various network servers through an IP network such as the Internet. The broadcast/multicast transport stream of the programs may be delivered to the hybrid terminal according to the below-discussed teachings of the present disclosure. It is noted here that because the teachings of the present disclosure equally apply to a transport stream delivered by a television broadcast network either via traditional broadcast means (terrestrial/satellite/cable means) or via IP multicast means, the term “hybrid terminal” is also used below to include a terminal that supports IP multicast functionality such as, for example, an IPTV terminal, an IP Set-Top Box (IP-STB), or a hybrid terminal having IPTV functionality such as, for example, when the hybrid terminal operates as an IP-STB for an IP delivered channel. Thus, strictly speaking, even if a “hybrid terminal” may not support the IPTV functionality in some embodiments, the term “hybrid terminal” is still primarily used below for the sake of convenience and ease of discussion, and is meant to refer to an IPTV terminal when a transport stream according to the teachings of the present disclosure is delivered via IP multicast means.

Similarly, the terms like “client,” “user,” “viewer,” “consumer,” “subscriber,” and other terms of similar import may be used interchangeably herein to essentially refer to an individual viewer—as opposed to all the users in a household—watching broadcast/multicast programs on a hybrid terminal. As above, the broadcast/multicast transport stream of the programs may be delivered to the hybrid terminal according to the teachings of the present disclosure, and the hybrid terminal may be configured as discussed below to process the received transport stream to provide the interactive viewing experience to the viewer. For ease of discussion, the terms “program” and “channel”, as in the case of a TV program or TV channel, may be used interchangeably herein as may be evident from the context.

It is observed that the term “advertisement” is used herein as an example of “interstitial programming,” which generally refers to textual, video, audio, or audio-visual content inserted at pre-determined ad insertion points or splice points in the linear flow of the main television programming being delivered to a hybrid terminal through broadcast/multicast. Thus, the teachings of the present disclosure may also apply to enable a user to interact with other non-advertisement type “interstitial programming” or content such as, for example, various non-commercial programs like video clips, news clips, a specific audio clip, and so on. For ease of understanding the principle of the present disclosure, however, the readily-recognized terms “advertisement” or “ad” have been primarily used in the discussion below merely as a convenient shorthand for the more generic term “interstitial programming.”

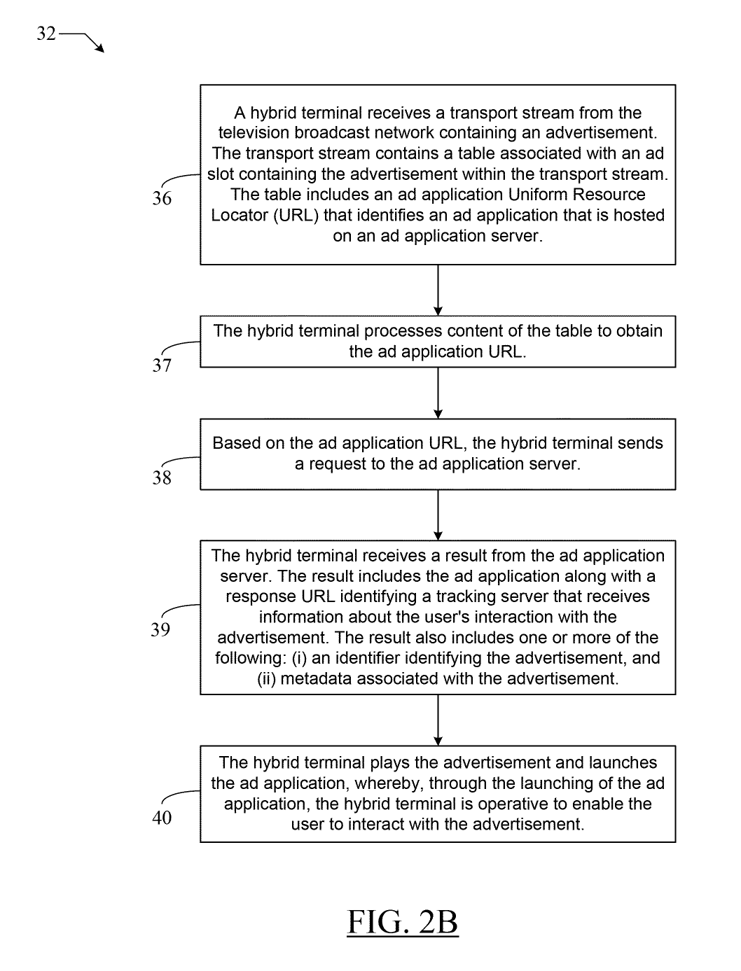

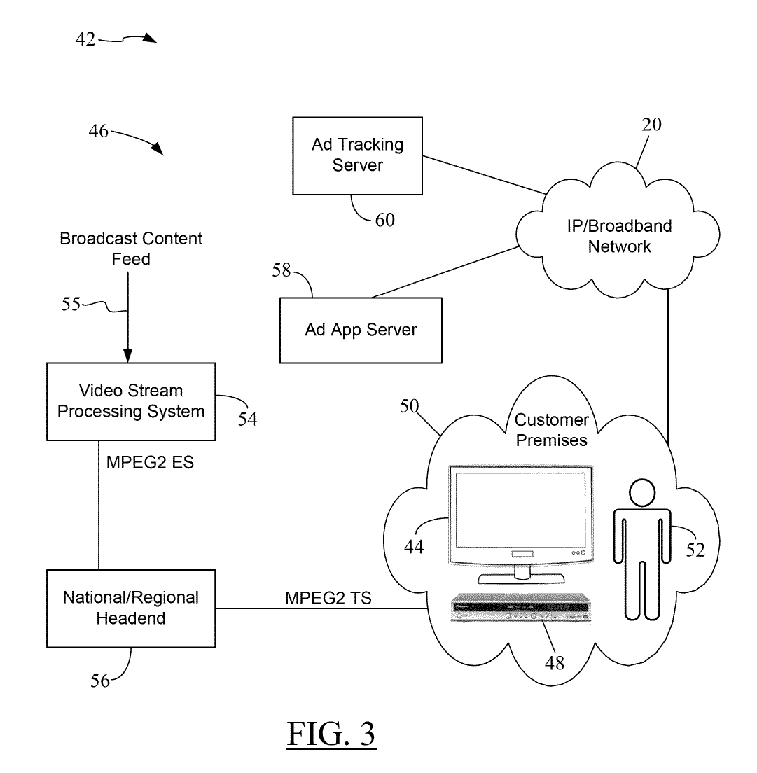

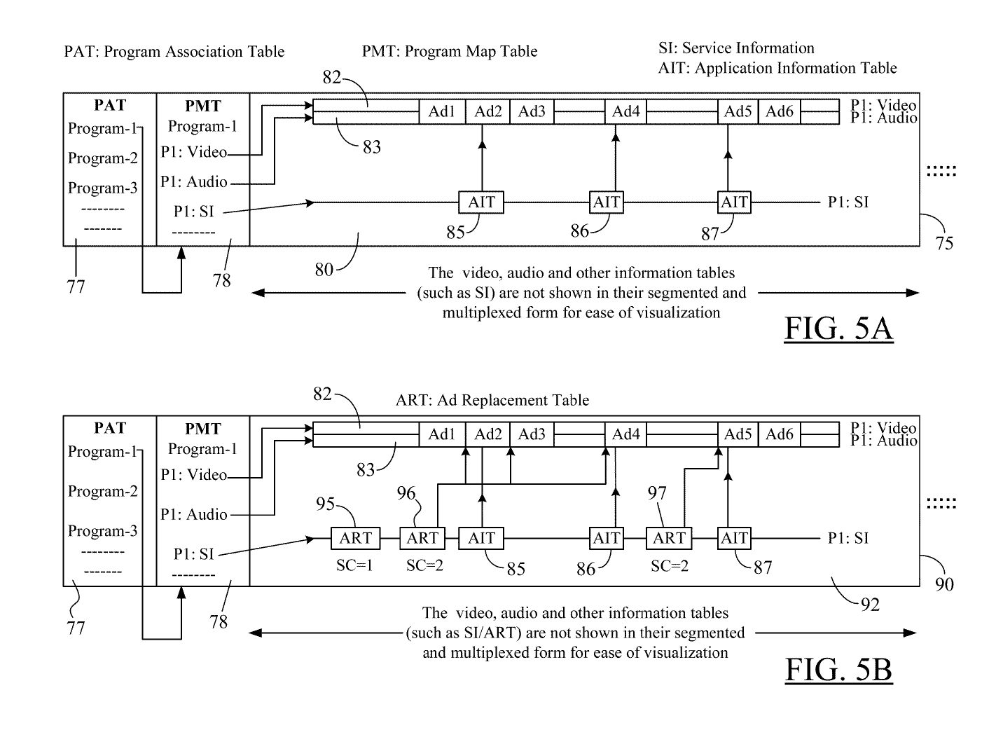

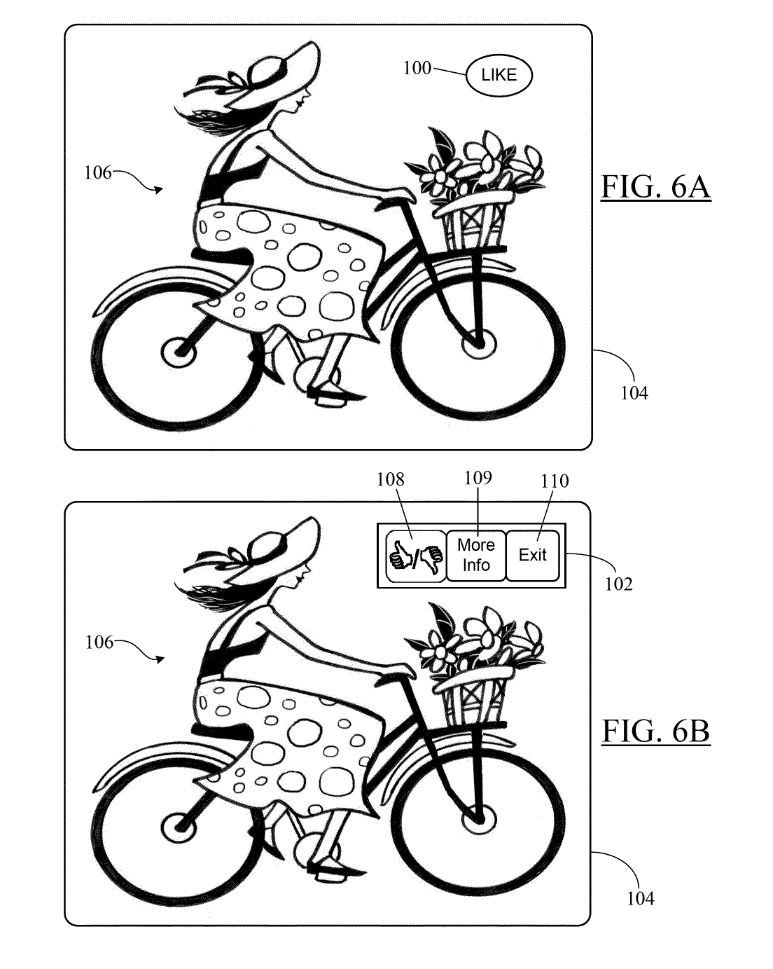

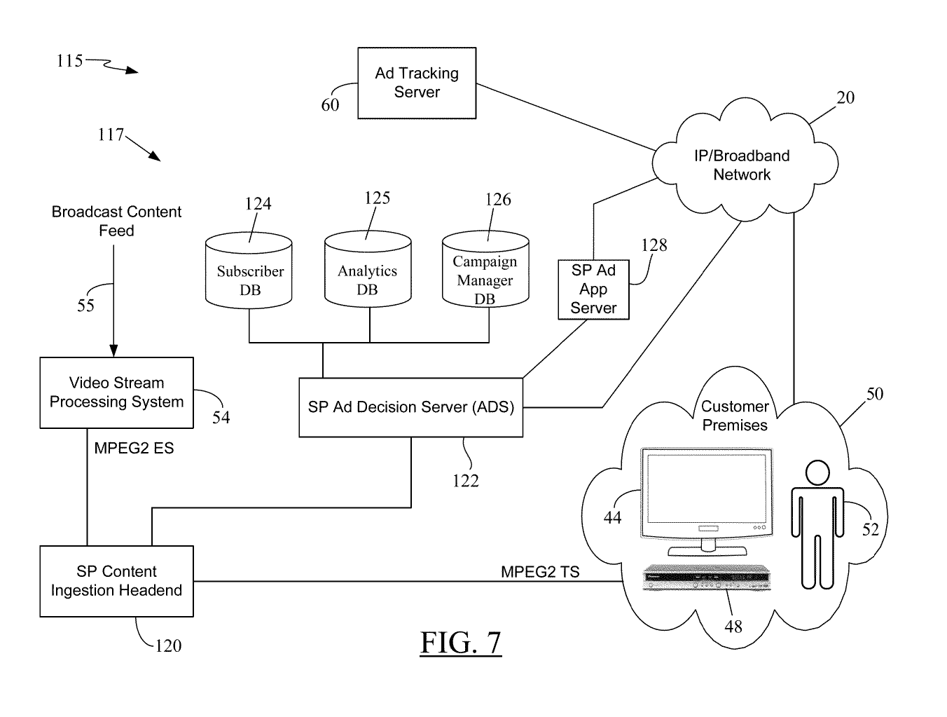

FIG. 2A is an exemplary flowchart 22 depicting various steps that may be performed by a television broadcast/multicast network such as, for example, the broadcast network 46 in FIG. 3 or the broadcast network 117 in FIG. 7, according to one embodiment of the present disclosure. The broadcast network may enable a user to interact with an advertisement or other interstitial content being played on a hybrid terminal associated with the user. The terminal may be coupled to the television broadcast network, which delivers the advertisement to the hybrid terminal. The hybrid terminal may be an IPTV terminal or a hybrid terminal with IPTV functionality. Initially, the television broadcast network may receive a broadcast content containing television programs (block 25). The broadcast content may be received from, for example, live satellite broadcast video feed in the form of analog or digital channels. At block 26, the broadcast network may create a transport stream of the broadcast content as well as any interstitial content such as an advertisement. The transport stream may be the earlier-mentioned MPEG2 TS. At block 27, the broadcast network may prepare a table associated with an ad slot containing the advertisement within the transport stream. As discussed in more detail below with reference to FIG. 5, the table prepared at block 27 may be the earlier-mentioned DVB SI AIT. The television broadcast network may place an ad application URL in that table, as noted at block 28. The ad application URL may identify an ad application that is hosted on an application server. As noted before, the ad application server identified in the ad application URL may operate as either (i) a forwarding proxy or (ii) a redirect proxy. The ad application, when launched by the hybrid terminal, may enable the user to interact with the advertisement associated with the DVB SI AIT table prepared at block 27. Thereafter, at block 29, the broadcast network may deliver the transport stream containing the table with the ad application URL to the hybrid terminal. As discussed in more detail below, the hybrid terminal may use the ad application URL to retrieve the ad application hosted by the ad application server. This ad application may be an auto-start application. Therefore, when the hybrid terminal plays the advertisement, the corresponding ad application is launched to thereby enable the user/viewer to interact with the advertisement as discussed later with reference to FIG. 6.

FIG. 2B is an exemplary flowchart 32 depicting various steps that may be performed by a hybrid terminal such as, for example, the hybrid terminal 44 in FIGS. 3 and 7, according to one embodiment of the present disclosure. Broadly speaking, the terminal-based steps in FIG. 2B may be considered as counterparts to the network-based actions depicted in FIG. 2A. The terminal may be associated with a user and may enable the user to interact with an advertisement being played on the hybrid terminal. The terminal may be coupled to a television broadcast/multicast network that delivers the advertisement to the terminal. At block 36, the hybrid terminal may receive a transport stream from the television broadcast network containing an advertisement for which interactivity is enabled. The transport stream may also contain television broadcast channels and may be an MPEG2 TS. In one embodiment, the transport stream may contain a table for an ad slot associated with the advertisement within the transport stream. As discussed in more detail below with reference to FIG. 5, the table may be a DVB SI AIT. The table may include an ad application URL that identifies an ad application hosted on an ad application server. In one embodiment, the ad application server may be a Service Provider's (SP's) Ad Decision Server (ADS) as discussed in more detail below in the context of FIG. 7. At block 37, the hybrid terminal may process the content of the received table to obtain the ad application URL. As noted at block 38, based on the retrieved ad application URL, the hybrid terminal may send a request to the ad application server. In response to the request, at block 39, the hybrid terminal may receive a result from the ad application server. The result may include the ad application hosted by the ad application server along with a response URL identifying a tracking server that receives information about the hybrid terminal user's interaction with the advertisement received at block 36. In one embodiment, the result may also include an identifier that identifies the advertisement and/or metadata associated with the advertisement. The ad application may be an auto-start application. As indicated at block 40, the hybrid terminal may play the advertisement and also launch the corresponding ad application received at block 39. Through launching of the ad application, the hybrid terminal may become operative to enable the user to interact with the advertisement as discussed later with reference to FIG. 6.

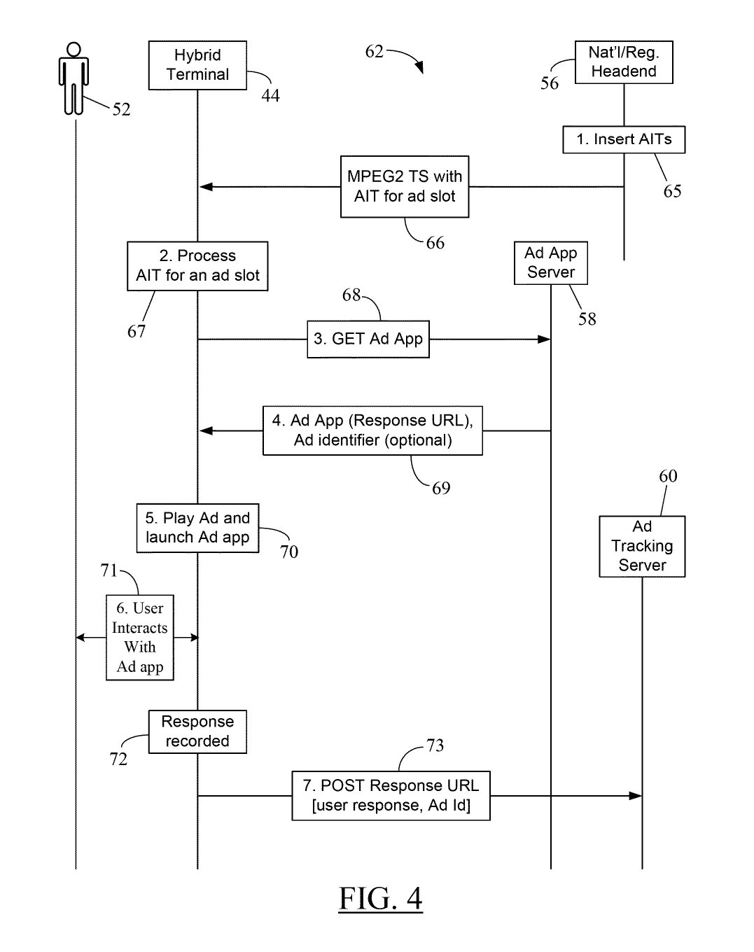

It is noted here that FIGS. 2A and 2B provide a general outline of various steps performed by a broadcast network and a hybrid terminal, respectively, to enable user interaction with an advertisement according to particular embodiments of the present disclosure. A more detailed discussion of those and other aspects according to the teachings of the present disclosure is provided with reference to FIGS. 4-6 and 8 below.

More generally, the transport stream-based table mentioned in FIGS. 2A-2B provides a means by which an autostart application may be signaled to an end user's terminal. The terminal can then request and receive the application from an ad application server. Upon execution of the application by the terminal, a user can interact with the TV advertisement associated with the application. Existing broadcast solutions do not provide the means by which the end user, having received an advertisement with interactivity enabled on his/her Smart TV, can express an opinion about it such as “liking” it, wishing for more of the same genre, requesting a long form video related to the ad content, ordering the product being advertised through the ad, and the like.

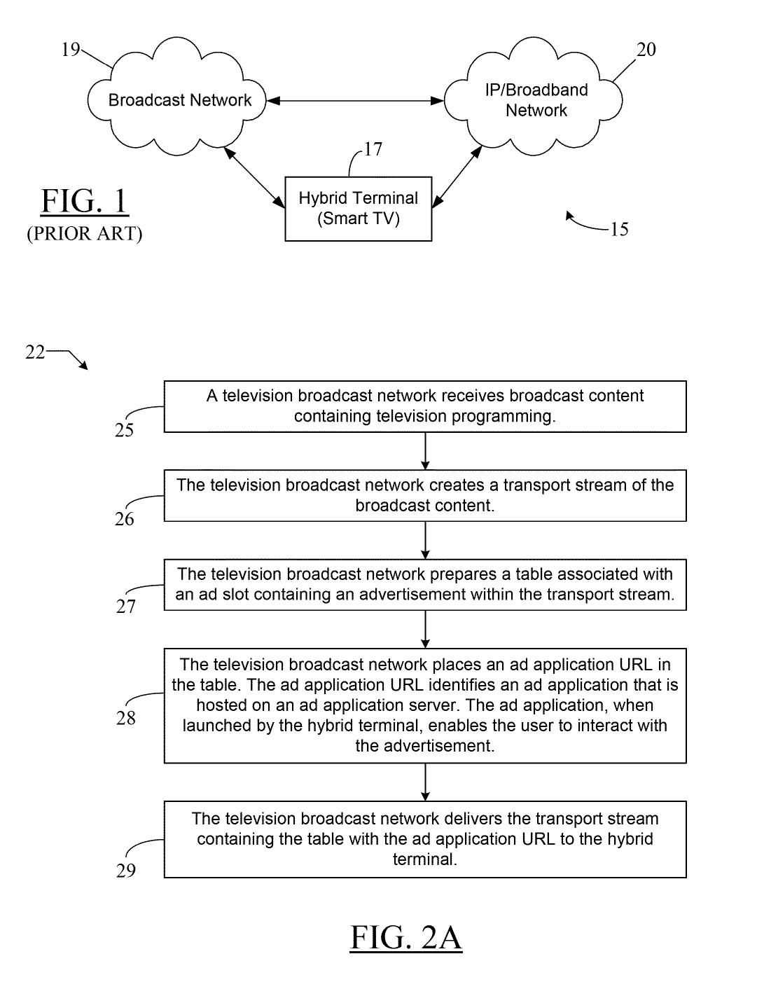

FIG. 3 illustrates exemplary details of a broadcast system 42 for enabling user interaction with an advertisement according to one embodiment of the present disclosure. The embodiment in FIG. 3 relates to interactivity with ads that are national, regional, or local, and are not replaced (or personalized) by the TV service provider (SP). On the other hand, the later-discussed embodiment of FIG. 7 relates to a case where the SP personalizes the ads to be sent to a hybrid terminal. Referring now to FIG. 3, a hybrid terminal 44 is shown to be connected to a broadcast network 46 configured according to the teachings of the present disclosure and also to a broadband IP network such as, for example, the broadband network 20 of FIG. 1. Thus, the hybrid terminal 44 in FIG. 3 operates under the same networked configuration as the hybrid terminal 17 in FIG. 1, except that the hybrid terminal 44 and the broadcast network 46 in FIG. 3 provide additional functionality to implement the teachings of the present disclosure and, hence, are different from the hybrid terminal 17 and the broadcast network 19 in FIG. 1. However, the hybrid terminal 44 and the broadcast network 46 support the general features of the hybrid terminal 17 and the broadcast network 19, respectively, discussed earlier and, hence, such discussion is not entirely repeated herein for the sake of brevity. For example, the hybrid terminal 44 may have different form factors such as, for example, an STB connected to a TV display, a smart TV, an HbbTV receiver, a digital media player, a Blu-ray player, a video game console, a digital hotel television system, and so on. In the embodiment of FIG. 3, the hybrid terminal 44 may not only provide conventional television functionality through its connection to the broadcast network 46, but may also have integrated Internet and web access features to enable it to support delivery of online and streaming interactive media, Internet TV or IPTV, and OTT content through its connection to the broadband network 20. Similarly, the broadcast network 46 may be, for example, a terrestrial broadcast TV network, a cable TV network, or a satellite TV network. The broadcast network 46 may be a fully digital network that supports a digital broadcast connection such as, for example, an ATSC, a DVB, or an ISDB based broadcast connection. The broadcast network 46 may deliver a transport stream as per teachings of the present disclosure via traditional broadcast means (terrestrial/satellite/cable means) or via IP multicast means. Hence, the terms “broadcast/multicast network” and “broadcast network” may be used interchangeably herein to refer to the broadcast network 46.

More generally, the term “hybrid terminal” in the present disclosure may refer to a function which has an application environment and two network interfaces—one interface for a broadcast connection and the other interface for a broadband connection. The hybrid terminal may also have at least two realizations—(i) the hybrid terminal realized in a Smart TV, and (ii) the hybrid terminal realized in a Set-Top Box (STB) attached to a pure display unit. Thus, a hybrid terminal according to particular embodiments of the present disclosure may operate in multiple application environments, and not just the OIPF/HbbTV browser based environment. For example, in addition to a browser-based environment, a hybrid terminal realized in an STB may also be able to support other application environments such as the Java-based environment standardized as DVB Multimedia Home Platform (DVB-MHP) in ETSI Technical Specification document 102 727.

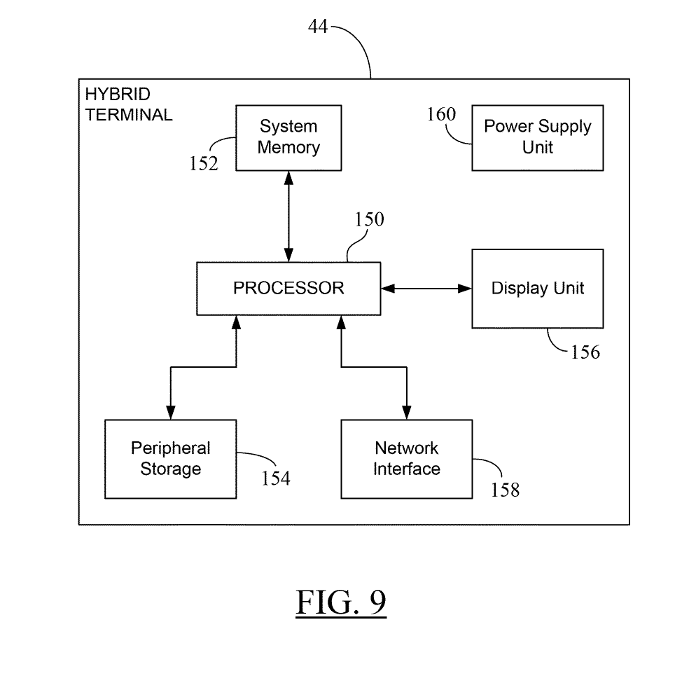

In one embodiment, the broadcast programming may be received through a Set-Top Box (STB) 48 in which case the terminal 44 operates simply as a TV display, or, alternatively, the hybrid terminal 44 may itself include the functionality of the STB 48 as part thereof, in which case the terminal 44 may directly receive broadcast programming. In another embodiment, the combination of the STB 48 and the terminal 44 may be considered to comprise a “hybrid terminal,” such as, for example, when the terminal 44 is a legacy TV that does not have smart TV functionality. In any event, despite the possibility of multiple realizations as noted above, a “hybrid terminal” is primarily referred to herein using only the single reference numeral “44” for ease of discussion. Exemplary architectural details of the hybrid terminal 44 according to one embodiment of the present disclosure are provided in FIG. 9 (discussed later). The STB 48 may be a service provider-specific receiver of broadcasted content/signals and may also be referred to as a Customer Premises Equipment (CPE). In one embodiment, the STB 48 may be an IP-STB supporting IPTV multicast functionality for IP delivered channels. In one embodiment, the hybrid terminal 44 or the STB 48 may be capable of receiving audio-visual content through Radio Frequency (RF) signals and converting the received signals into signals that are compatible with an appropriate display device such as, for example, an analog/digital television or computer monitor. The hybrid terminal 44 may be capable of receiving cable-based as well as non-cable based audio-visual content. Such content may include, for example, Internet Protocol TV (IPTV) content, cable TV programming, satellite or other broadcast TV channels, Over-The-Top (OTT) streaming video, Over-The-Air (OTA) live programming, Video-On-Demand (VOD) content from a cable service provider or a non-cable network operator, Time Shifted Television (TSTV) content, programming delivered from a Digital Video Recorder (DVR) or a Personal Video Recorder (PVR) or a Network-based Personal Video Recorder (NPVR), and so on. In one embodiment, the hybrid terminal 44 may operate in an IP-STB manner for an IP delivered channel such as, for example, an IPTV multicast channel. As noted before, for ease of discussion, the term “hybrid terminal” is primarily used herein to refer to a terminal that receives a transport stream from the broadcast network 46 as per teachings of the present disclosure—whether through traditional broadcast means or through IP multicast means—and supplements the presentation of that transport stream with information/application/content from a broadband network.

The hybrid terminal 44 may be present at a location 50, also referred to as “customer premises”. An exemplary user/viewer 52 is shown to be present at the location 50 and watching broadcasted programs on the hybrid terminal 44. The location 50 may be a home, a hotel room, a dormitory room, and the like. In certain embodiments, the viewer 52 may not be the owner/proprietor of the hybrid terminal 44, but can still interact with ads as per teachings of the present disclosure. It is understood that there may be more users and more hybrid terminals at the customer premises 50, but only one of each is shown in FIG. 3 for ease of illustration.

In one embodiment, the hybrid terminal 44 may communicate with the broadband network 20 using Transmission Control Protocol (TCP)/IP-based data communication. As noted before, the broadband network 20 may be, for example, the Internet including portions of one or more wireless networks as part thereof. In one embodiment, the hybrid terminal 44 may communicate wirelessly with the broadband network 20, for example, through a wireless connection between a customer premises-based broadband access network (not shown) and the broadband network 20.

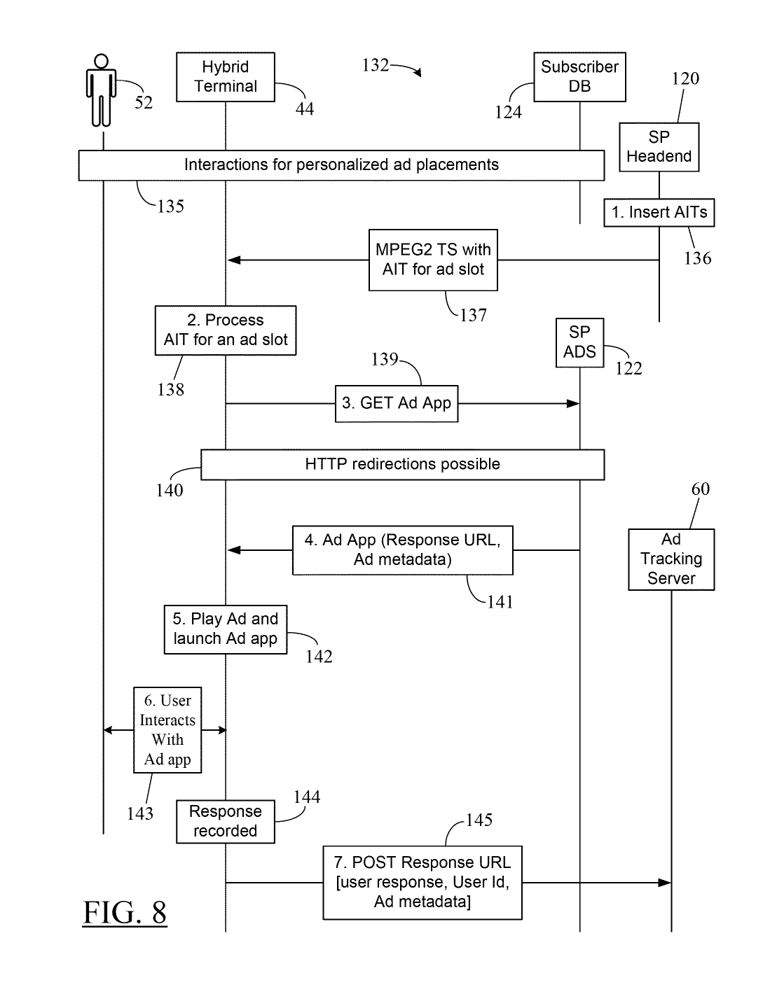

In one embodiment, the broadcast network 46 may include a video stream processing system (VPS) 54 to provide an elementary stream, such as, for example, an MPEG2 Elementary Stream (ES), of the received broadcast content feed at arrow 55. The VPS 54 may be coupled to (or in communication with), for example, a satellite receiver (not shown), which may receive live satellite broadcast video feed in the form of analog or digital channels from a satellite antenna (not shown). The received channels may be then delivered to customer premises 50 via a service provider's network. Prior to processing the received live video data, the VPS 54 may communicate with an ad server (not shown) to obtain any local/regional/national ads to be inserted into the linear programming of the broadcast feed. The ads may be then inserted in the broadcast video feed and included as part of the MPEG2 TS. In one embodiment, the ad server may be part of the broadcast network 46. However, in another embodiment, the ad server may be a separately-managed server providing ad content to the broadcast network 46, but not being part of the broadcast network 46. It is observed here that the local/regional/national ads may be those ads that are typically broadcasted to all households or subscribers in a particular geographic region or locale. Hence, these ads may be considered “generic” when contrasted with the ads that may be “personalized” by the broadcast TV service provider (SP) for a particular subscriber or household. The embodiments in FIGS. 7-8 relate to interactivity in the context of such personalized ads.

In the embodiment of FIG. 3, the broadcast network 46 may also include a national/regional headend 56 that receives the elementary stream of the broadcast content (including national/regional ads) from the VPS 54 and generates a transport stream therefrom. The transport stream may be sent to an SP's network (not shown) for eventual delivery to a subscriber location 50. The SP may deliver the transport stream to the hybrid terminal 44. In one embodiment, the transport stream may be an MPEG2 TS that includes a table such as, for example, the earlier-mentioned DVB SI Application Information Table (AIT), which contains a link to an ad application as discussed in more detail below. Two exemplary MPEG2 transport streams with DVB SI AITs are discussed below with reference to FIGS. 5A-5B. It is observed here that the embodiment of FIG. 3 illustrates that the headend 56 in the broadcast network 46 delivers the MPEG2 transport stream via traditional broadcast means (terrestrial/satellite/cable means). However, in another embodiment, the headend 56 may deliver the MPEG2 TS to the customer premises 50 via IP multicast means such as, for example, an IPTV multicast channel delivered to the hybrid terminal 44 through the broadband network 20. Thus, although the discussion below primarily refers to the traditional broadcast-based content delivery, it is understood that all such discussion equally applies to embodiments where the broadcast network 46 delivers a transport stream—configured as per teachings of the present disclosure—via IP multicast means. Hence, a separate IP multicast-based discussion is not provided herein.

It is known that most current digital broadcast television systems are based on the MPEG transport stream standard. The MPEG2 TS is a standard format for transmission and storage of audio, video, and Program and System Information Protocol (PSIP) data, and is used in broadcast systems such as DVB, ATSC, and ISDB. Transport stream specifies a container format for encapsulating the packetized elementary stream content, with error correction and stream synchronization features for maintaining transmission integrity when the signal is degraded. Transport streams are designed for less reliable transmissions, such as terrestrial or satellite broadcasts. A transport stream may carry multiple programs or “channels,” as shown, for example, in FIGS. 5A-5B discussed later.

As shown in FIG. 3, an ad application server 58 and an ad tracking server 60 may be connected to the broadband network 20 and, hence, accessible to the hybrid terminal 44 via the broadband network 20. In one embodiment, either or both of these servers may be part of the broadcast network 46. As discussed in more detail below, the ad application server 58 may provide the advertisement-specific application to the hybrid terminal 44 to enable user interactivity as per particular embodiments of the present disclosure. The tracking server 60, on the other hand, may receive from the hybrid terminal 44 information/feedback about user's interactions or lack thereof with the ad associated with a particular ad application launched by the hybrid terminal 44. Additional operational details of various entities shown in the exemplary broadcast system 42 are provided later below in conjunction with discussion of FIGS. 4-6.

FIG. 4 shows an exemplary signaling flow 62 for user interaction with national or regional ads according to one embodiment of the present disclosure. The signaling flow 62 is illustrated in the context of the entities shown in the broadcast system 42 in FIG. 3. Hence, the signaling flow 62 relates to the case where the ads are regional/local/national ads not personalized by a service provider (SP) for a specific user. In the embodiments of FIGS. 3-4, the SP may simply retain the ads received from a national/regional headend, such as the headend 56, and pass them along to its subscribers. In that regard, the SP may also pass through any AIT inserted by the national or regional headend. Before discussing the numbered steps 1 through 7 associated with reference numerals 65-73 in FIG. 4, it is noted that this numbering is provided for ease of discussion only; it does not imply that these steps must be performed in the described order in all the embodiments of the present disclosure. Also, in certain embodiments, one or more steps may be combined, altered, or omitted, or additional steps may be present, as per desired implementation.

In step-1 (block 65), the programming headend 56 may create DVB SI AIT tables for all ad slots for which it enables interactivity. The interactivity aspects of the main TV programs may not be relevant to the interactivity of interstitial programming as per teachings of the present disclosure. In the embodiment of FIG. 4, each ad-related AIT may contain a link/URL to an ad application provided by the programmer's or ad campaign's Ad Application Server, such as the ad application server 58. As noted earlier, the ad application server 58 may provide auto-start applications related to different ads in the transport stream of broadcast content. These applications may be referred to as “ad apps” herein for brevity.

The block 66 illustrates delivery of the MPEG2 TS of the broadcast content to the hybrid terminal 44. The MPEG2 TS from the national/regional headend 56 may include regular TV programming as well as one or more ads. The headend 56 may include in the MPEG2 TS an AIT associated with an ad slot containing the advertisement for which interactivity is enabled.

In step-2 (block 67), the hybrid terminal 44 may process the received MPEG2 TS for a channel being viewed by the terminal's user 52. During the processing, the terminal 44 may notice the presence of an AIT at or shortly after the start of the ad insertion slot that contains the advertisement the user 52 can interact with.

In step-3 (block 68), the hybrid terminal 44 may dereference the URL for the ad application server 58 identified by the AIT. In one embodiment, the hybrid terminal 44 may de-reference the URL using a Hypertext Transfer Protocol (HTTP) GET request. As part of the HTTP GET request, the terminal 44 may use an XML HTTP Request (XHR) (where “XML” refers to Extensible Markup Language) technique or another equivalent mechanism to send a request for the ad application to the ad application server 58. Additional details of such XHR requesting may be obtained from the World Wide Web Consortium (W3C) Working Draft titled “XML HTTP Request Level 1” (Jan. 30, 2014) or its subsequent revisions, available at www.w3c.org; the relevant disclosure of this document is incorporated herein by reference in its entirety. In one embodiment, the terminal 44 may send its HTTP GET request for an ad app to the ad application server 58 via the broadband network 20. The action at block 68 may be done in the background without any user interaction or without affecting the user's viewing experience.

In step-4 (block 69), the ad application server 58 may return a response that includes the requested ad-related application. The ad app may contain the logic to enable the user to interact with the corresponding ad when the ad app is launched by the hybrid terminal 44. The logic may also allow the hybrid terminal 44 to report the user's response to the ad or interaction with the ad to the tracking server 60, as discussed below. In one embodiment, the user response may be directed at a URL—referred to as a “Response URL” at block 69—embedded within the ad app. The Response URL may identify the tracking server 60 that receives information about the user's interaction with the ad. There may be alternative ways to send the user response other than through the use of HTTP. The result at block 69 may optionally include an identifier (Ad ID) for the ad being viewed and which the user response will be sent. In one embodiment, the ad identifier may be needed if the ad app was “generic” or the same for all advertisements. In that case, the ad identifier may identify/distinguish each corresponding ad separately, despite the common ad app. In another embodiment, the result at block 69 may also include metadata associated with the advertisement that corresponds to the ad app being returned at block 69.

In step-5 (block 70), the terminal 44 may play the advertisement and launch the ad-related application retrieved in step-4. The ad app, when launched by the hybrid terminal 44, may cause the terminal 44 to display a user interface (UI) overlaid with a specific degree of transparency on a portion of the advertisement. The UI may offer one or more choices selectable by the user 52 to enable the user to interact with the advertisement. The UI of this ad-related app in step-4 can be one of several chosen entirely by the ad campaign or the programmer. For example, the UI can be a red button (or any other colored button) shown on some portion of the terminal's display screen with the words “Like?”. As another example, the UI can be a discreet translucent overlay on a portion of the screen while the ad is showing, with choices such as “More information?” (or up/down keys to indicate a desire for more/less information) or “Exit?”. Two exemplary user interfaces are shown in FIGS. 6A-6B discussed below.

The step-6 (block 71) indicates user's interaction with the ad app—as manifested through its user interface. If the user 52 makes no choice on the UI or fails to interact with the ad app through the UI, the ad app's UI may disappear after an application-specific period. Thus, the ad app, when launched by the terminal 44, may cause the terminal to stop displaying the UI if the user fails to interact with the ad during a pre-determined, application-specific time period. Such time period may depend, for example, on the duration of the corresponding ad. Thus, for example, if an ad runs for 30 seconds and if the associated UI appears on the screen 5 seconds after the ad has started, then the ad app may cause the terminal 44 to remove the UI after it has been on screen for 15 seconds without any response from the user 52.

In the context of the examples discussed above with reference to step-5 (block 70), if the user 52 makes a choice by pressing a colored button or using the up/down keys, the key press or chosen item/option may be recorded by the terminal 44 as noted at block 72. The ad app, upon launch or execution by the terminal 44, may enable the terminal 44 to perform such recording of the user's response for further processing in step-7 (block 73).

In step-7 (block 73), the user's choice/response may be sent to the tracking server 60 according to the logic contained in the ad app. In one embodiment, the choice may be sent along with any ad identifier (Ad ID) provided in the response in step-4 (block 69). In one embodiment, the terminal 44 may send this choice using the earlier-mentioned XHR to POST the user response to the tracking server's URL embedded in the ad app. If the user has failed to interact with the ad or select one of the offered choices on the ad's UI, the response at block 73 may contain a report informing the tracking server 60 that the user has failed to interact with the ad during a pre-determined time period. It is observed here that there may be no security risk in step-7 because the response is sent back to the same domain from which the ad app is received.

If the ad slot discussed in FIG. 4 is followed by another ad slot with interactivity, the broadcast network 46 may trigger an AIT update at the transition point. In one embodiment, the national/regional headend 56 performs such AIT update. As a result of the AIT update, the hybrid terminal 44 may retrieve a new ad application for displaying its UI during the next ad slot. This retrieval process may be similar to that illustrated in FIG. 4. In one embodiment, the AIT update may provide a URL of a different ad application. As before, this new add ad application, when launched by the hybrid terminal 44, may enable the user 52 to interact with a new advertisement contained in the subsequently-occurring ad slot associated with the AIT update.

It is observed that the ad app for the earlier ad should be closed by the hybrid terminal 44 before the new ad slot starts. Hence, in one embodiment, the headend 56 in the broadcast network 46 may send an AIT termination message to the hybrid terminal 44 via the MPEG2 TS to instruct the terminal to terminate any previously-invoked ad app before the subsequently-occurring ad slot starts. For those hybrid terminals or smart TVs that can only support a single app, the launch of the new interactive ad's application may force the previous ad app to be terminated. However, some application environments may support multiple applications to be active at the same time, although with only one of them having “focus”, i.e., be in the foreground, in which case the AIT termination message may be used to close inactive apps at the terminals offering such an application environment.

It is observed from the process shown in FIG. 4 that the user response reported to the tracking server 60 at block 73 does not identify a specific user. Thus, for national or regional ad campaigns, the ad tracking server 60 may get user feedback data anonymously. This is in contrast to the user ID based reporting in the embodiment of FIG. 8 discussed below.

If the hybrid terminal 44 permits, it may be possible to provide a slightly more targeted response at block 73 by using the terminal's Media Access Control (MAC) address—suitably anonymized by hashing—to provide information associated with the user's response. In this embodiment, the hybrid terminal 44 may be configured to provide its MAC address to the ad tracking server 60 as part of the response at block 73. Along with the Ad ID, the “linking” of the MAC address of the terminal 44 with a user's response may allow the tracking server 60 to correlate several user responses on different advertisements associated with this terminal 44. Hence, a terminal-specific “tracking” of user feedback may be possible. On the other hand, the embodiment in FIG. 8 may provide a user-specific tracking as discussed later below.

FIGS. 5A-5B (collectively “FIG. 5”) illustrate how AITs may be sent via an MPEG2 TS according to particular embodiments of the present disclosure. FIG. 5A shows an MPEG2 TS 75 including two Program Specific Information (PSI) tables—a Program Association Table (PAT) 77, and a Program Map Table (PMT) 78. The TS 75 is also shown with the broadcasted TV content portion 80 for one of the programs—here, Program-1—mentioned in the PAT 77. As is known, a PAT lists all programs available in the transport stream. Each of the listed programs may have an associated Packet Identifier (PID) value for its PMT. Thus, PMTs contain information about programs listed in the PAT. There may be one program-specific PMT for each program listed in the PAT. For example, an exemplary PMT for Program-1 (or P1) in the PAT 77 is shown using reference numeral “78” in FIG. 5A. The PMTs provide information on each program present in the transport stream, including the program number, and list the elementary streams that comprises the described MPEG2 program. For example, the PMT 78 for Program-1 indicates and the TS content portion 80 shows that P1 contains a video stream (P1: Video) 82, an audio stream (P1: Audio) 83, and Service Information (SI) tables 85-87, among other content. The SI tables 85-87 may be DVB SI AITs as shown in FIG. 5. In the illustrations of FIGS. 5A-5B, the AIT 85 is associated with an ad slot or advertisement block “Ad2”, the AIT 86 is associated with the ad slot “Ad4,” and the AIT 87 is associated with the ad slot “Ad5.” Although each of the ad slots “Ad1” through “Ad6” in FIG. 5 may contain a respective advertisement to be shown to the viewer 52, only the ads contained in the three ad slots “Ad2”, “Ad4,” and “Ad5” may have interactivity enabled for them. Hence, only three corresponding AITs 85-87 are shown in FIG. 5. As noted earlier, these AITs 85-87 may be created or inserted by a headend, such as the headend 56 in FIG. 3, in the transport stream 80 for Program-1 to “cue” the hybrid terminal 44 to retrieve corresponding ad apps to enable user interaction with ads in the respective ad slots.

It is pointed out here that, in FIGS. 5A-5B, the video, audio, and other information tables, such as the DVB SI AITs and the below-mentioned Ad Replacement Tables (ARTs), are not shown in their segmented and multiplexed form for ease of visualization. In an actual implementation, an MPEG2 TS may carry many different broadcasted programs and each program may have its own set of such SI tables. Also, there may be other PIDs and audio or video streams for each program (such as supplomental audio, overlay sign language, etc.) or information tables carrying subtitling/captioning information. Hence, all of these tables for such programs may be segmented and/or multiplexed during transmission of the TS to a subscriber terminal. It is also pointed out here that the MPEG2 TS shown in FIGS. 5A-5B is used as an example of a transport stream for broadcast/multicast programs, and, similarly, the DVB SI AIT and ART are also used as examples of transport stream-based tables as per the teachings of the present disclosure. Similar tables may be implemented in a non-DVB system such as, for example, in an ATSC or ISDB defined transport stream.

FIG. 5B shows an MPEG2 TS 90 including the PAT 77, the PMT 78, and a broadcasted TV content portion 92 for the Program-1 mentioned in the PAT 77. For ease of discussion, the same reference numerals are used in FIGS. 5A and 5B to refer to the same tables/content, but the reference numeral “92” is used in FIG. 5B for the program portion of Program-1 to distinguish it from the program portion 80 in FIG. 5A because of the presence of the ARTs 95-97 in the TS 90 of FIG. 5B. Thus, the TS 90 in FIG. 5B is similar to the TS 75 in FIG. 5A, except that the TS 90 includes SI tables/ARTs 95-97 (which may be DVB SI tables in one embodiment) in addition to the AITs 85-87. The ARTs 95-97 enable the hybrid terminal 44 to manage placement of personalized ads for the viewer 52 in the identified ad slots during playback of regular TV programs. Thus, in contrast to the generalized ads in the embodiment in FIG. 5A, the ART-based embodiment in FIG. 5B allows for delivery of individualized, user-specific ads. As shown in FIG. 5B, the initial ART 95 may contain a different indication—the Service Code (SC)=1 value—than each subsequent ART 96-97 with the value of SC=2. The initial ART 95 may “prepare” the hybrid terminal 44 to receive a list of personalized ads individually selected for the viewer 52. For example, upon receipt of the ART 95, the hybrid terminal 44 may contact a server, such as the Ad Decision Server 122 in FIG. 7, for an ad list, and the subsequent ARTs 96-97 may enable the hybrid terminal to insert personalized ads in their corresponding ad slots. As shown in the embodiment of FIG. 5B, the ART 96 may instruct the hybrid terminal 44 to insert personalized ads in the ad slots “Ad2” through “Ad4,” whereas the ART 97 may instruct the hybrid terminal 44 to insert a personalized ad in the ad slot “Ad5.” As noted, the personalized ads may be delivered to a user/viewer through ARTs in a broadcast program's transport stream. Thus, in the embodiment of FIG. 5B, a viewer may not only receive personalized ads through ARTs, but may also be able to interact with some of those ads through corresponding AITs. The later-discussed embodiment of FIG. 7 shows a system in which personalized ads may be delivered to a viewer via a broadcast/multicast transport stream.

FIGS. 6A-6B (collectively “FIG. 6”) illustrate two exemplary user interfaces (UIs) 100, 102 that may be displayed to a user, such as the user 52 in FIGS. 3-4, when corresponding ad apps are launched by a hybrid terminal, such as the hybrid terminal 44 in FIGS. 3-4, according to particular embodiments of the present disclosure. In FIG. 6, a display screen 104 of the hybrid terminal 44 is shown with an exemplary advertisement 106 being played back to the viewer 52. If this ad 106 has interactivity enabled therefor, the hybrid terminal 44 may launch a corresponding ad app using the exemplary process illustrated in FIG. 4. Upon launch, the ad app may cause the hybrid terminal 44 to display on its display screen 104 a UI overlaid with a specified degree of transparency on a portion of the advertisement. As noted before, the UI may offer one or more choices selectable by the user to enable the user to interact with the advertisement. For ease of discussion, the same ad 106 is shown in FIGS. 6A-6B, but with two different UIs 100, 102 to provide examples of UIs that may be displayed to a user. Other types of UIs having different shapes, sizes, content, and color scheme than those shown in FIG. 6 may be possible as well. The illustrations in FIGS. 6A-6B do not imply that the ad app associated with the ad slot for the ad 106 switches from one UI 100 to the other 102 while the ad 106 is being played. In practice, the same type of UI may be consistently displayed during different ads, or different ads may have different UIs. The focus in FIGS. 6A-6B is not on the content of the ad 106, but on the availability and display of a UI as per teachings of the present disclosure to enable interaction with the corresponding ad.

In the embodiment of FIG. 6A, the UI 100 is a semi-transparent oval, which can be a a colored icon with the color representing an association with the actual/physical colored button on the remote control (not shown), shown on a portion of the screen 104 with the word “Like.” The UI 100 thus allows the user 52 watching the ad 106 to express his/her opinion about the ad by selecting the “Like” choice using the hybrid terminal's remote control (not shown) if the user likes the ad 106 being displayed. In contrast to the simple UI 100 in FIG. 6A, the exemplary UI 102 in FIG. 6B provides more choices for the user 52. As shown in FIG. 6B, the UI 102 may provide a first choice 108 selectable by the user 52 to indicate whether the user likes the ad (when the “thumbs up” sign is toggled) or not (when the “thumbs down” sign is toggled); a second choice 109 selectable by the user 52 to indicate that the user desires more information related to the advertisement 106; and a third choice 110 selectable by the user 52 to indicate that the user wishes to skip/exit the overlay on the advertisement 106. Other examples of choices that may be displayed—either alone or with other choices—to a user for interaction include: (i) “e-mail me a discount coupon” for the product/item being advertised, (ii) “call me so I can order” the product/item in the advertisement, and (iii) “directly order the product.” It is understood that the choices discussed here are just some examples; other similar or different choices may be offered as well.

If the user selects the choice 109 in the embodiment of FIG. 6B to request more information about the ad 106, the hybrid terminal 44 may report this choice to the ad tracking server 60 using the process at block 73 in FIG. 4. In one embodiment, the tracking server 60 may respond by providing a URL of a site where the user 52 can gain more information on the material related to the ad, along with a visual request for the user 52 to click on the link for more information. The URL and the request information may be sent to the hybrid terminal 44 via the broadband network 20. In one embodiment, the hybrid terminal 44 may then display the URL on the screen 104 along with the visual request for the user 52 to navigate using his remote control and click on the displayed URL.

FIG. 7 shows exemplary details of a broadcast system 115 for delivering personalized ads and for enabling user interaction with such ads according to one embodiment of the present disclosure. For ease of discussion, common entities or entities having similar functionalities in the embodiments of FIGS. 3 and 7 are identified using the same reference numerals. In view of the discussion of FIG. 3, a detailed discussion of such common entities is not repeated herein for the sake of brevity. In FIG. 7, the hybrid terminal 44 is shown connected to the broadband network 20 and a broadcast network 117 configured according to the teachings of the present disclosure. Except for certain differences (discussed below) and the SP-based implementation in the embodiment of FIG. 7, the broadcast network 117 may be substantially similar to the regional/national operator based broadcast network 46 in FIG. 3. Hence, features common between the broadcast networks 46 and 117 are not further discussed below. For example, like the broadcast network 46, the network 117 may be a terrestrial or over-the-air broadcast TV network, a cable TV network, or a satellite TV network. Also, the broadcast network 117 may be a fully digital network that supports a digital broadcast connection such as, for example, an ATSC, a DVB, or an ISDB based broadcast connection. The broadcast network 117 may also deliver a transport stream as per teachings of the present disclosure via traditional broadcast means (terrestrial/satellite/cable means) or via IP multicast means. The hybrid terminal 44 may receive a transport stream from the broadcast network 117 as per teachings of the present disclosure—whether through traditional broadcast means or through IP multicast means.

In the embodiment of FIG. 7, the viewer 52 may not be the owner/proprietor of the hybrid terminal 44, but can still receive personalized ads and interact with them so long as the viewer 52 somehow conveys his/her personal user preferences and viewer-specific information to the broadcast network 117. Like the broadcast network 46, the broadcast network 117 may also comprise an ad server (not shown). However, in contrast to the regional/national headend 56 in the broadcast network 46 of FIG. 3, the broadcast network 117 may include a Service Provider (SP) content ingestion headend 120 and an SP Ad Decision Server (ADS) 122. The service provider headend 120 may receive the elementary stream of the broadcast content from the VPS 54 and may generate a transport stream therefrom. The transport stream may be then delivered to the hybrid terminal 44. In one embodiment, the transport stream may be an MPEG2 TS that includes SI tables such as, for example, the earlier-mentioned ARTs and AITs shown in the exemplary embodiment of FIG. 5B. The ARTs may replace the existing/traditional ad insertion markers, such as the Society of Cable Telecommunications Engineers 35 (SCTE 35) markers according to the SCTE standards such as, for example, the American National Standards Institute (ANSI)/SCTE 35 standard, titled “Digital Program Insertion Cueing Message for Cable” (2013), available at www.scte.org, but the ARTs may contain information corresponding to those replaced markers. Like the headend 56 in FIG. 3, the SP-specific headend 120 may also deliver the MPEG2 transport stream via traditional broadcast means (terrestrial/satellite/cable means) or via IP multicast means such as, for example, an IPTV multicast channel delivered to the hybrid terminal 44 through the broadband network 20.

As shown in FIG. 7, the SP headend 120 may be operatively coupled to the SP ADS 122. In the absence of a personalized ad for the viewer 52, the SP ADS 122 may provide guidance to the SP headend 120 regarding which national/regional or other “generic” advertisement to place in the MPEG2 TS being delivered to the hybrid terminal 44. The ADS 122 may have access to one or more databases such as, for example, a subscriber database (DB) 124, an analytics DB 125, and a campaign manager DB 126. In one embodiment, these databases 124-126 may be part of the broadcast network 117 as well. In certain implementations, these databases 124-126 may be servers or server-based data storage systems. The subscriber DB 124 may store user-specific personal information of the user 52. Such personal information may include, for example, the user's personal viewing preferences, the user's age, gender, and other personal interests the user may have shared with the service provider. The analytics DB 125 may store demographic information as well as more dynamic information related to the user's previous viewing activity, what other users with similar interests watched in the past, and so on. The campaign manager DB 126 may store information related to currently ongoing ad campaigns to assist the ADS 122 in selecting the most personalized ad(s) that matches with the user's preferences from the currently active ad campaigns.

As shown in FIG. 7, in one embodiment, the servers 60 and 122 in the broadcast network 117 may be connected to the broadband network 20 and, hence, accessible to the hybrid terminal 44 via the broadband network 20. In the embodiment of FIG. 7, an exemplary SP ad application server 128 is shown in communication with the SP ADS 122. Like the ad application server 58 in FIG. 3, the ad application server 128 in FIG. 7 may also provide advertisement-specific applications to the hybrid terminal 44 to enable user interactivity as per particular embodiments of the present disclosure. In one embodiment, the ad application server 128 may be part of the broadcast network 117. In one embodiment, the ad application server 128 may not directly receive a request for the ad application from the hybrid terminal 44. Rather, the ADS 122 may act as a redirect proxy for the ad application server, whereby the ADS 122 first receives such request from the hybrid terminal 44 and responsively provides the URL of the ad application hosted on the ad application server 128 to the hybrid terminal 44 to enable the hybrid terminal 44 to then directly send the request to the app server 128 over the broadband network 20. On the other hand, it may be possible for the SP to implement a system in which the SP's ad application server 128 directly receives the request for the ad app, like the embodiment in FIG. 4. In one embodiment, upon receiving the request from the hybrid terminal 44, the ad application server 128 may directly send a result to the hybrid terminal, wherein the result may include the requested ad app along with a response URL of the tracking server 60. Alternatively, the ADS 122—acting as a forwarding proxy—may initially receive such result from the ad application server 128 and then forward the result to the hybrid terminal 44. Relevant additional operational details of various entities shown in the exemplary broadcast system 115 are provided later below in conjunction with discussion of FIG. 8.

The embodiment of FIG. 7 makes use of a broadcast network's backend systems/databases 124-126 to enable a hybrid terminal to make an ad placement decision. The hybrid terminal 44 may initially provide a user “token” which identifies the user's preferences in the SP's subscriber database 124. The subscriber database provides the necessary targeting matched with additional information based on analytic data and ongoing ad campaigns to substantially personalize the delivery of advertisements. The use of ARTs, as in the embodiment of FIG. 5B, allows the SP headend 120 to provide an augmented service field in the transport stream to identify to the hybrid terminal 44 both the ADS 122 (to be contacted by the terminal for user-specific ads) as well as placement opportunities in the upcoming ad slots. In this manner, the ads may be truly personalized for a specific end user.

It is noted here that the interactivity aspects of the present disclosure apply to any type of ads, whether personalized (as in case of the embodiment in FIGS. 7-8) or not (as in case of the embodiment in FIGS. 3-4).

FIG. 8 depicts an exemplary signaling flow 132 for user interaction with SP-personalized ads according to one embodiment of the present disclosure. This is in contrast to the signaling flow 62 in FIG. 4 which related to user interaction with non-personalized regional/national ads. However, there is still an overall similarity between these two signal flows, as can be seen from a comparison of FIGS. 4 and 8. Hence, the discussion of FIG. 8 primarily focuses on the changes compared to the embodiment in FIG. 4. A pre-requisite to facilitate delivery of personalized advertising by the SP is that the end user 52 may need to provide user-specific information to the service provider. The user-specific information may include, for example user's age, gender, as well as user's personal viewing preferences such as, for example, favorite genres, interests, hobbies, shows, and the like. The user may provide his/her personal information in as much detail as desired. The more the user shares their preferences with the service provider, the better the SP may be able to populate the available advertisement slots in the broadcasted transport stream with appropriate personalized content. This aspect is depicted by block 135 in FIG. 8 where it is noted that the user 52 may interact with the subscriber DB 124 to add/store user preferences in the subscriber database 124. In one embodiment, the user 52 may use the hybrid terminal 44 or other web-enabled device such as, for example, a computer or a tablet, to access the subscriber DB 124 via the broadband network 20. In another embodiment, the user 52 may provide his/her preferences at the time of signing up for the SP's services and as part of setting up his/her subscriber account with the SP. In one embodiment, the service provider may assign a User ID to the user 52 or allow the user 52 to select a User ID, which, the user 52 may be later send to the ADS 122 via the user's hybrid terminal 44 to receive personalized ads. The selected or assigned User ID may be stored in the subscriber DB 124 as part of subscriber account information for the user 52.

Thus, an SP may select personalized ads based on an end user's identity and the user's interactions with the SP's ADS and/or database(s), and the SP may then signal the selected personalized ads to the hybrid terminal 44 via a broadcast/multicast transport stream.

It is noted here that, like FIG. 4, the numbered steps 1 through 7 associated with reference numerals 136-145 in FIG. 8 are provided for ease of discussion only; it does not imply that these steps must be performed in the described order in all the embodiments of the present disclosure. Also, in certain embodiments, one or more steps may be combined, altered, or omitted, or additional steps may be present, as per desired implementation.

In step-1 (block 136), the SP headend 120 may populate a new DVB SI AIT table with a link/URL to the ad application on the SP's ADS server 122 for those ad placements which have been personalized by the SP and for which interactivity has been enabled. An example of the URL to the ADS 122 may be: http://SP.com/ADSserver/ad-slot1. In contrast to the embodiment in FIG. 4, the ADS 122 in the embodiment of FIG. 8 may act as a reverse proxy for the back-end servers that process any ad placements and provide ad-specific ad apps for interactivity. Thus, the URL containing the ADS 122 may be provided at block 136 instead of that containing an ad application server as in case of the block 65 in FIG. 4.

In the personalization-based embodiment of FIG. 8, the SP headend 120 may remove any AIT already present in the transport stream and replace it with its own, or add new AITs for ads for which it wishes to enable interactivity. The block 137 illustrates delivery of the MPEG2 TS of the broadcast content to the hybrid terminal 44. The MPEG2 TS from the SP's headend 120 may include regular TV programming as well as one or more personalized ads. The headend 120 may include in the MPEG2 TS an AIT associated with an ad slot containing the (personalized) advertisement for which interactivity is enabled.

In step-2 (block 138), the hybrid terminal 44 may process the received MPEG2 TS for a channel being viewed by the terminal′ user 52. During the processing, the terminal 44 may notice the presence of an AIT at or shortly after the start of the ad insertion slot that contains the advertisement the user 52 can interact with.

In step-3 (block 139), the hybrid terminal 44 may de-reference the URL identified by the AIT processed in step-2 using an HTTP GET request. As mentioned with reference to block 136, the URL contains the address of the SP ADS 122 acting as a forwarding proxy or reverse proxy for, among other entities, the SP ad application server 128. More details about the XHR-based HTTP GET is provided earlier with reference to discussion of block 68 in FIG. 4. As a result of the de-referencing at block 139, the hybrid terminal 44 may send an HTTP GET request to the SP ADS 122 to receive the ad app associated with the respective AIT. The request may be sent via the broadband network 20 and this request-sending action may be done in the background without any user interaction or without affecting the user's viewing experience.

As indicated at block 140, several HTTP redirections may be possible at this stage because the ADS 122, acting as a redirect proxy, may redirect the request received from the terminal 44 to the appropriate SP ad application server, for example, the server 128 in FIG. 7. Eventually, the SP ad application server 128 may receive the request.

In step-4 (block 141), the SP ad application server 128 may return a result that includes the SP's ad-related application. Although not shown in FIG. 8, in one embodiment, the ad application server 128 may directly send the result to the terminal 44 via the broadband network 20. However, in another embodiment, the ad application server 128 may send the result to the ADS 122, which may then forward it to the terminal 44, as shown in FIG. 8. As before, the ad app may contain the logic to enable the user to interact with the corresponding ad when the ad app is launched by the hybrid terminal 44. The logic may also allow the hybrid terminal 44 to report the user's response to the ad or interaction with the ad to the tracking server 60. In one embodiment, the user response may be directed at a URL—referred to as a “Response URL” at block 141—embedded within the ad app. The Response URL may provide the “address” to which the user response should be returned. Hence, in one embodiment, the Response URL may identify the tracking server 60 that receives information about the user's interaction with the ad. There may be alternative ways to send the user response other than through the use of HTTP. The result at block 141 may optionally include the metadata for the ad to which this ad app is associated and for which the user response will be sent. The metadata may include such information as ad's duration, ad's title, ad's genre, ad's source (identifying the source that has created or supplied this personalized ad to the viewer), the year the ad was released, and the like.

In step-5 (block 142), the terminal 44 may play the advertisement and launch the ad-related application retrieved in step-4. The ad application, when launched by the hybrid terminal 44, may cause the terminal 44 to display a UI overlaid with a specific degree of transparency on a portion of the advertisement. In one embodiment, the UI may be one of several chosen by the service provider. The UI may offer one or more choices selectable by the user 52 to enable the user to interact with the advertisement. This step-5 (block 142) is similar to the step-5 (block 70) in FIG. 4 and, hence, additional discussion of block 142 is not provided herein. The earlier-discussed FIGS. 6A-6B illustrate two exemplary user interfaces, which may be applicable to block 142 as well.

The step-6 (block 143) and block 144 in FIG. 8 are identical to the corresponding step-6 (block 71) and block 72 in FIG. 4 and, hence, additional discussion of blocks 143-144 is not provided herein.

In step-7 (block 145), the launched ad app may configure the hybrid terminal 44 to return the user's choice/response to the entity the ad app has been preconfigured with—here, the tracking server 60 whose response URL is contained in the ad app received at block 141. The ad app may also configure the terminal 44 to send, as part of the response at block 145, some information which identifies to the SP the user 52 of the hybrid terminal 44. In one embodiment, such identifying information may be the same user ID as that was sent to the SP as part of the interactions at block 135 to identify the user 52 to the SP and was then used by the SP to personalize the actual ad for the user 52. As mentioned earlier, the ads may be personalized based on the user ID. In one embodiment, the user's response information at block 145 may also optionally include the ad metadata received at block 141. As in case of the block 73 in FIG. 4, the terminal 44 may use the earlier-mentioned XHR to POST the user response to the tracking server's URL embedded in the ad app. If the user has failed to interact with the ad or select one of the offered choices on the ad's UI, the response at block 145 may contain a report informing the tracking server 60 that the user has failed to interact with the ad during a pre-determined time period. It is observed here that even if the ad tracking server 60 is an SP-specific tracking server—such as a tracking server owned/operated/managed by the SP—there still may be no security risk in step-7 (block 145) because the response is sent back to the same domain (that of the SP) from which the ad app is received.

If the ad slot discussed in FIG. 8—in the context of block 137 onwards—is followed by another ad slot with interactivity, the broadcast network 117 may insert an AIT update at the transition point between the two ad slots. In one embodiment, the SP headend 120 may perform such AIT update. As a result of the AIT update, the hybrid terminal 44 may retrieve a new ad application for displaying its UI during the next ad slot. This retrieval process may be similar to that illustrated in FIG. 8. In one embodiment, the steps to terminate the previous ad app are the same as that discussed earlier with reference to FIG. 4 and, hence, are not repeated here.

In the context of step-3 (block 139) in FIG. 8, it is observed that, in one embodiment, the request at step-3 may lead to an HTTP redirect from the SP ADS 122 to another URL. This URL may be that of the ad content owner who will provide the necessary ad application. In one embodiment, this redirection can be handled through Cross-Origin Resource Sharing (CORS) by ensuring that the app provider's domain is recognized by the SP domain. One advantage of this alternative is that it frees the SP from designing the ad application. Additional details about CORS may be obtained from the document titled “Cross-Origin Resource Sharing,” W3C Recommendation (Jan. 16, 2014), available at www.w3c.org.

In one embodiment, a generic ad app can be delivered in advance to the hybrid terminal 44. Such advance delivery may precede the receipt of an AIT. This may give rise to two possibilities, depending on the implementation: (i) It may be possible for the generic ad app to be running at the hybrid terminal 44, but without its UI having visual appearance on the display screen of the hybrid terminal 44. In such a case, the subsequent AIT signaling may cause the ad app's UI to gain focus and show itself. (ii) In this option, although the ad app is pre-delivered to the hybrid terminal 44, the ad app may be actually launched only when the AIT is received. In both of these cases, the AIT may include data to configure the ad app for the particular ad slot. Such data may include ad metadata to identify the ad that is to be shown at this ad slot, and the URL to which any user interaction response should be sent.

It is observed in the context of the embodiment in FIG. 8 that reporting of user interactions at block 145 may allow the service provider to receive a direct feedback on whether the personalized ad selections that it made for the user 52 were indeed “liked” by the user, thereby improving SP's future ad decisions. In the case where there is a generic/non-personalized ad placement done at a national/regional/local level such as, for example, in case of the embodiment in FIG. 4, user interactivity as defined by the teachings of the present disclosure may help the service provider build a better analytics database for ad placements. In one embodiment, this may be done by the SP adding an AIT for a national ad so that when a user at a hybrid terminal interacts with the ad, the user's response to the SP's tracking server includes the ad identifier which was obtained by evaluating the advertisement for an embedded watermark conveying that information. In the case that the ad placement is personalized as mentioned before, the SP may gain confirmation (based on the response at block 145) on the accuracy of SP's analytics results which led to the ad selection for the user 52.

The user interaction supported as per teachings of the present disclosure may also provide an indication of audience measurement to the advertiser. As discussed before, when a Smart TV or other hybrid terminal receives the AIT carrying the URL to the interactive application, the terminal may fetch the application from the URL. Because the terminal/smart TV has responded to a signal in the transport stream, it indicates that the terminal was tuned to the respective channel at that time. In one embodiment, it may be possible to insert different URLs for the same ad application, such that viewership or audience measurement of a particular TV channel may be measured. However, terminals that do not support the Smart TV feature or hybrid terminal functionality would ignore the advertisement's AIT and, hence, may not be measured.

It also may be possible for a service provider to work in a commercial relationship with the ad provider to create the UI for the corresponding ad app, including the questions put to the user through the UI. This approach may allow the results—such as a request for more information related to the content of the ad—to be sent to the ad provider who can service this need in some manner.

In particular embodiments, the broadcast networks 46 and 117 may be service provider's networks. In case of the broadcast network 117, in one embodiment, one or more of the network components 54, 120, 122, 124-126, and 128 may be owned, managed, or operated by the service provider, such as, for example, a cable TV service provider or a satellite network operator. On the other hand, in case of the broadcast network 46, the network components 54, 58, and 60 may be owned, managed, or operated by the service provider. In other embodiments, only a portion of the broadcast networks 46 or 117 may be SP-controlled. Such portion may include, for example, the ad application server 58 or 128 and/or the tracking server 60. Other network components in the broadcast networks 46, 117 may be controlled, managed, or operated by a different network operator or by more than one commercial entity. Other similar or alternative commercial arrangements may be envisaged for ownership, operation, management, or support of various component systems shown in FIGS. 3 and 7. In any event, all of the business entities associated with the broadcast network 46 or 117—through ownership, management, or control of one or more network servers or databases—may have appropriate licensing or operating agreements therebetween to enable smooth/seamless provisioning of interactive ads, personalized ads, and other interstitial programming to the subscriber 52. Generally, who owns or manages a specific system component shown in FIG. 3 or 7 is not relevant to the overall interactive ad-based content delivery solution discussed in the present disclosure.

It is noted here that exemplary architectural details of the hybrid terminal 44 are shown in FIG. 9 and discussed later below. However, for ease of illustration and sake of brevity, no such architectural details are provided for other processing entities 48, 54, 56, 58, 60, 120, 122, 124-126, and 128 shown in the embodiments of FIGS. 3 and 7. It is understood, though, that at least some of these remaining entities, such as, for example, the servers 58, 60, 122 and 128, may have a similar architectural configuration in particular embodiments. In certain other embodiments, each of the entities 48, 54, 56, 58, 60, 120, 122, 124-126, and 128 may include a respective memory (not shown) to store the program code to carry out the relevant entity-specific processing steps discussed below. An entity's processor(s) (not shown) may invoke/execute that program code to implement the desired functionality. For example, in one embodiment, upon execution by a processor (not shown) in the ad application server 58 or 128, the program code in the ad application server 58/128 may cause the server 58/128 to supply ad apps requested by the hybrid terminal 44. Similarly, one or more processors in the ADS 122 may execute relevant program code to query the databases 124-126 to select the most appropriate, personalized ad for the viewer 52. In summary, the processing entities 48, 54, 56, 58, 60, 120, 122, 124-126, and 128, or any other processing entity not shown in FIGS. 3 and 7, but may be needed to effectuate the user interaction with ads according to teachings of the present disclosure, may be configured (in hardware, via software, or both) to carry out the relevant entity-specific processing steps discussed herein. Thus, although the processing entities 48, 54, 56, 58, 60, 120, 122, 124-126, and 128 may be referred to herein as “performing,” “accomplishing,” or “carrying out” a function or process, it is evident to one skilled in the art that such performance may be technically accomplished in hardware and/or software as desired.

In one embodiment, a service provider—whether a cable network operator, satellite broadcast service provider, or any other entity—may offer a subscription-based, a non-subscription based, or free service to deliver targeted and interactive ad content to a hybrid terminal through a modified transport stream, such as the exemplary transport streams shown in FIG. 5. The service provider's servers or databases may be accessible to the user's hybrid terminal through a broadband network. In particular embodiments, such service provider may supply the DVB SI tables through an MPEG2 TS to enable the user's hybrid terminal to download appropriate advertisements and ad apps from respective content servers, which may or may not be owned/operated/managed by the service provider. Thus, various functionalities discussed in the present disclosure may be offered as a commercial or non-commercial service.

FIG. 9 is a block diagram of an exemplary hybrid terminal, such as the terminal 44 in FIGS. 3 and 7, according to one embodiment of the present disclosure. In one embodiment, as noted before, the terminal 44 may be an IPTV terminal, or a hybrid terminal supporting IPTV functionality or including IP-STB features to process IP multicast content. As mentioned before, the hybrid terminal 44 in FIG. 9 may be configured to perform the relevant terminal-based operations discussed before with reference to FIGS. 2B through 8. Thus, in one embodiment, the terminal 44 may include a processor 150 that may be “configured” in hardware and in software, if necessary, to support the user interactions with ads as per the teachings of the present disclosure. In FIG. 9, the processor 150 is shown coupled to a system memory 152, a peripheral storage unit 154, an output device such as a display unit 156, and a network interface unit 158. In some embodiments, the terminal 44 may include more than one instance of the devices 152, 154, 156, and 158 shown in FIG. 9.

In particular embodiments, the processor 150 may include more than one core, and/or the terminal 44 may include more than one processor, for example, in a distributed processing configuration. When the terminal 44 is a multiprocessor system, there may be more than one instance of the processor 150 or there may be multiple processors (not shown) coupled to the processor 150. It will be appreciated that terminal-related tasks discussed hereinbefore represent various processes which may be substantially performed by the processor 150 in FIG. 9. The processor 150 may include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. The processor may also employ distributed processing in certain embodiments.

In various embodiments, the system memory 152 may comprise any suitable type of non-transitory memory, such as Fully Buffered Dual Inline Memory Module (FB-DIMM), Double Data Rate or Double Data Rate 2, 3, or 4 Synchronous Dynamic Random Access Memory (DDR/DDR2/DDR3/DDR4 SDRAM), Rambus® DRAM, flash memory, and of various types of Read Only Memory (ROM), and the like. In one embodiment, the system memory 152 may include multiple discrete banks of memory controlled by discrete memory interfaces in the embodiments of the processor 150 that provide multiple memory interfaces. Also, in some embodiments, the system memory 152 may include multiple different types of memory, as opposed to a single type of memory. In one embodiment, the system memory 152 may store program code, which may be executed by the processor 150 and, upon execution, the hybrid terminal 44 may be operative to perform various terminal-related steps discussed hereinbefore.

Some or all aspects of the hybrid terminal-based tasks or processing steps may be implemented in a computer program, software, firmware, or microcode incorporated in a non-transitory, computer-readable storage medium, such as the memory 152, for execution by a general purpose computer or a processor, such as the processor 150. In particular embodiments, such computer-readable medium may be part of the peripheral storage 154, or may be part of the system memory 152 or a processor's internal memory, like the internal memory (not shown) of the processor 150. The processor 150 may execute instructions stored on a related computer-readable medium to carry out the software-based processing to enable the hybrid terminal 44 to perform terminal-related steps discussed hereinbefore. Examples of computer-readable storage media include a Read Only Memory (ROM), a Random Access Memory (RAM), a digital register, a cache memory, a cloud-based storage system, semiconductor memory devices, magnetic media such as internal hard disks, magnetic tapes and removable disks, magneto-optical media, and optical media such as CD-ROM disks and Digital Versatile Disks (DVDs).

The peripheral storage unit 154, in various embodiments, may include support for various non-transitory storage media such as, for example, magnetic, optical, magneto-optical, or solid-state storage media like hard drives, optical disks (such as CDs or DVDs), non-volatile RAM devices, and the like. In some embodiments, the peripheral storage unit 154 may include more complex storage devices/systems such as disk arrays (which may be in a suitable RAID (Redundant Array of Independent Disks) configuration) or Storage Area Networks (SANs), which may be coupled to the processor 150 via a standard Small Computer System Interface (SCSI), a Fibre Channel interface, a Firewire® interface (Institute of Electrical and Electronics Engineers (IEEE) 1394 interface), or another suitable interface.

In particular embodiments, the hybrid terminal 44 may be operative to receive and process signals from a user-operated remote control (not shown). The display unit 156 may provide a display of the received TV program and interactive/non-interactive advertisements along with ad app-based user interface(s) inserted by the processor 150 into the corresponding interactive ads. In one embodiment, the display unit 156 may include a TV screen with an audio speaker. An exemplary TV screen 104 is shown in FIG. 6. The TV screen may be touch-sensitive in particular embodiments.

In one embodiment, the network interface unit 158 may communicate with the processor 150 to enable the terminal 44 to couple to the broadcast network 46/117 and the broadband network 20. The broadcast television interface portion of the unit 158 may allow the hybrid terminal 44 to receive broadcast television programming. On the other hand, the broadband interface portion of the unit 158 may allow the hybrid terminal 44 to interact with television broadcast network servers, retrieve multicast television programming, receive advertisements for subsequent playout, and so on. The interface unit 158 may be configured to enable the hybrid terminal 44 to connect to other types of data networks as well. In one embodiment, the interface unit 158 may include any suitable devices, media and/or protocol content for connecting the hybrid terminal 44 to other devices or entities—whether through wired or wireless means, and whether within a single network or over a combination of networks, including the Internet.

In one embodiment, the hybrid terminal 44 may include an on-board power supply unit 160 to provide electrical power to various system components illustrated in FIG. 9. The power supply unit 160 may receive batteries or may be connectable to an AC electrical power outlet. In one embodiment, the power supply unit 160 may convert solar energy into electrical power.

It is noted here that one or more of the processing entities shown in FIGS. 3 and 7, such as the VPS 54, the headends 56 and 120, the tracking server 60, the ad app servers 58 and 128, the ADS 122, the STB 48, and the databases 124-126, may have architectural configuration similar to the hybrid terminal's configuration in FIG. 9. In some embodiments, these entities may include more or less functional components than those shown in FIG. 9. However, for the sake of brevity, architectural details of each such entity is neither shown nor described in detail in view of the discussion of the configuration in FIG. 9. It is observed, however, that, in alternative embodiments, one or more of these entities and/or the hybrid terminal 44 may include additional components responsible for providing additional functionality, including any of the functionality identified above and/or any functionality necessary to support the solution as per the teachings of the present disclosure. Although features and elements are described above in particular combinations, each feature or element can be used alone without the other features and elements or in various combinations with or without other features and elements. As mentioned before, the functions of various entities shown in FIGS. 3 and 7, as well as those of the hybrid terminal 44 in FIG. 9, may be provided through the use of hardware (such as circuit hardware) and/or hardware capable of executing software/firmware in the form of coded instructions or microcode stored on a computer-readable medium (mentioned above). Thus, such functions in the embodiments of FIGS. 2A-8 are to be understood as being either hardware-implemented and/or computer-implemented, and thus machine-implemented.

The foregoing describes a system and method that enables a user to interact with a broadcasted advertisement and express an opinion about it. Particular embodiments of the present disclosure describe how the end user, having received an ad for which interactivity is enabled, can interact with that ad, for example, by “liking” it or expressing an opinion on it or interacting with it in some other ways. Such user interactivity is provided through an HbbTV auto-start application, which is associated with an advertisement event/slot and a link/URL to the auto-start application is carried in a DVB AIT table of the broadcast/multicast transport stream associated with the TV program channel on which the advertisement is to be shown. The hybrid terminal receiving the AIT-containing transport stream may retrieve the auto-start application using the URL before the corresponding ad is played back to the viewer. When the ad is played, the retrieved application is simultaneously launched. The launched application's UI may allow the user to interact with the ad or express an opinion about the content of the ad. The present disclosure also provides for the tracking of a user's interaction with an advertisement.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of enabling a user to interact with an advertisement being played on a hybrid terminal associated with the user, wherein the hybrid terminal is coupled to a television broadcast network that delivers the advertisement to the hybrid terminal, and wherein the method comprises performing the following:
the television broadcast network receiving broadcast content containing television programming;
the television broadcast network creating a transport stream of the broadcast content;
the television broadcast network preparing a table associated with an ad slot containing the advertisement within the transport stream;
the television broadcast network placing an ad application Uniform Resource Locator (URL) in the table, wherein the ad application URL identifies an ad application that is hosted on an ad application server, and wherein the ad application, when launched by the hybrid terminal, enables the user to interact with the advertisement; and
the television broadcast network delivering the transport stream containing the table with the ad application URL to the hybrid terminal.

2. The method of claim 1, wherein the method further comprises:
the ad application server receiving a request for the ad application from the hybrid terminal; and
the ad application server sending a result to the hybrid terminal, wherein the result includes the ad application along with a response URL identifying a tracking server that receives information about the user's interaction with the advertisement,
wherein the result further includes one or more of the following:
an identifier identifying the advertisement, and
metadata associated with the advertisement.

3. The method of claim 2, wherein the ad application, when launched by the hybrid terminal, causes the hybrid terminal to display a user interface overlaid with a specified degree of transparency on a portion of the advertisement and offering one or more choices selectable by the user to enable the user to interact with the advertisement.

4. The method of claim 3, wherein the ad application, when launched by the hybrid terminal, causes the hybrid terminal to stop displaying the user interface if the user fails to interact with the advertisement within a pre-determined time period.

5. The method of claim 4, wherein the ad application, when launched by the hybrid terminal, causes the hybrid terminal to report to the tracking server that the user has failed to interact with the advertisement within the pre-determined time period.

6. The method of claim 3, wherein the method further comprises one of the following:
the tracking server receiving information from the hybrid terminal about a choice selected by the user through the user interface; and
the tracking server receiving information from the hybrid terminal that the user has failed to select a choice through the user interface.

7. The method of claim 2, wherein at least one of the following is part of the television broadcast network: the ad application server; and the tracking server.

8. The method of claim 1, wherein the transport stream is a Motion Picture Experts Group 2 (MPEG2) Transport Stream (TS), and wherein the table is a Digital Video Broadcast (DVB) Service Information (SI) Application Information Table (AIT).

9. The method of claim 8, wherein the method further comprises:
the television broadcast network triggering an AIT update for a subsequently-occurring ad slot within the MPEG2 TS so as to provide a URL of another ad application to the hybrid terminal, wherein the other ad application, when launched by the hybrid terminal, enables the user to interact with a new advertisement contained in the subsequently-occurring ad slot; and
the television broadcast network sending an AIT termination message to the hybrid terminal for any previously invoked ad application before the subsequently-occurring ad slot starts.

10. A method of enabling a user to interact with an advertisement being played on a hybrid terminal associated with the user, wherein the hybrid terminal is coupled to a television broadcast network that delivers the advertisement to the hybrid terminal, and wherein the method comprises performing the following by the hybrid terminal:
receiving a transport stream from the television broadcast network containing the advertisement, wherein the transport stream contains a table associated with an ad slot containing the advertisement within the transport stream, and wherein the table includes an ad application Uniform Resource Locator (URL) that identifies an ad application that is hosted on an ad application server;
processing content of the table to obtain the ad application URL;
based on the ad application URL, sending a request to the ad application server;
receiving a result from the ad application server, wherein the result includes the ad application along with a response URL identifying a tracking server that receives information about the user's interaction with the advertisement, wherein the result further includes one or more of the following:
a first identifier identifying the advertisement, and
metadata associated with the advertisement; and
playing the advertisement and launching the ad application, whereby, through the launching of the ad application, the hybrid terminal is operative to enable the user to interact with the advertisement.

11. The method of claim 10, wherein the method comprises further performing the following by the hybrid terminal upon launching the ad application:
displaying a user interface overlaid with a specified degree of transparency on a portion of the advertisement, wherein the user interface includes one or more choices to enable the user to interact with the advertisement; and
removing the displayed user interface if the user fails to interact with the advertisement within a pre-determined time period.

12. The method of claim 11, wherein the method comprises further performing one of the following by the hybrid terminal upon launching the ad application:
recording a choice selected by the user through the user interface and reporting information about the user-selected choice to the tracking server using the response URL;
or using the response URL, reporting to the tracking server that the user has failed to interact with the advertisement within the pre-determined time period.

13. The method of claim 12, wherein the method comprises further performing the following by the hybrid terminal upon launching the ad application:
using the response URL, reporting at least one of the following to the tracking server:
the first identifier identifying the advertisement;
the metadata associated with the advertisement;
a second identifier identifying the user; and
a Media Access Control (MAC) address of the hybrid terminal.

14. The method of claim 10, wherein the transport stream is a Motion Picture Experts Group 2 (MPEG2) Transport Stream (TS), and wherein the table is a Digital Video Broadcast (DVB) Service Information (SI) Application Information Table (AIT).

15. The method of claim 14, wherein the method comprises further performing the following by the hybrid terminal:
receiving an AIT termination message from the television broadcast network; and
terminating the launched ad application in response to the AIT termination message.

16. A television broadcast network for enabling a user to interact with an advertisement being played on a hybrid terminal associated with the user, wherein the hybrid terminal is coupled to the television broadcast network that delivers the advertisement to the hybrid terminal, and wherein the television broadcast network comprises:
a video processing system that receives broadcast content containing television programming and generates a Motion Picture Experts Group 2 (MPEG2) Elementary Stream (ES) of the broadcast content; and
a headend coupled to the video processing system and the hybrid terminal, wherein the headend is operative to:
create an MPEG2 Transport Stream (TS) from the MPEG2 ES of the broadcast content,
prepare a Digital Video Broadcast (DVB) Service Information (SI) Application Information Table (AIT) associated with an ad slot containing the advertisement within the MPEG2 TS,
place an ad application Uniform Resource Locator (URL) in the DVB SI AIT, wherein the ad application URL identifies an ad application that is hosted on an application server, and wherein the ad application, when launched by the hybrid terminal, enables the user to interact with the advertisement, and
deliver the MPEG2 TS containing the DVB SI AIT with the ad application URL to the hybrid terminal.

17. The television broadcast network of claim 16, wherein the television broadcast network further comprises:
the application server, wherein the application server is operative to:
receive a request for the ad application from the hybrid terminal; and
send a result to the hybrid terminal, wherein the result includes the ad application and a response URL identifying a tracking server that receives information about the user's interaction with the advertisement.

18. A hybrid terminal for enabling a user to interact with an advertisement being played on the hybrid terminal, wherein the hybrid terminal is coupled to a television broadcast network that delivers the advertisement to the hybrid terminal, and wherein the hybrid terminal comprises:
a display unit for displaying the advertisement to the user;
a memory for storing program instructions;
a network interface for receiving broadcast and broadband content; and
a processor coupled to the memory, the display unit, and the network interface, and configured to execute the program instructions, whereby the hybrid terminal is operative to:
receive a Motion Picture Experts Group 2 (MPEG2) Transport Stream (TS) containing the advertisement from the television broadcast network, wherein the MPEG2 TS contains a Digital Video Broadcast (DVB) Service Information (SI) Application Information Table (AIT) associated with an ad slot containing the advertisement within the MPEG2 TS, and wherein the DVB SI AIT includes an ad application Uniform Resource Locator (URL) that identifies an ad application that is hosted on an application server,
process the DVB SI AIT to obtain the ad application URL,
based on the ad application URL, send a request to the application server via a broadband Internet Protocol (IP) connection,
receive a result from the application server, wherein the result includes the ad application,
play the advertisement on the display unit,
launch the ad application, and
in response to launching the ad application, display a user interface on the display unit overlaid with a specified degree of transparency on a portion of the advertisement, wherein the user interface includes one or more choices to enable the user to interact with the advertisement.

19. The hybrid terminal of claim 18, wherein, upon execution of the program instructions by the processor, the hybrid terminal is further operative to remove the displayed user interface if the user fails to interact with the advertisement within a pre-determined time period.

20. The hybrid terminal of claim 18, wherein the result received from the application server includes a response URL identifying a tracking server that receives information about the user's interaction with the advertisement, and wherein, upon execution of the program instructions by the processor, the hybrid terminal is further operative to perform one of the following:
record a choice selected by the user through the user interface and report information about the user-selected choice to the tracking server using the response URL; and
use the response URL to report to the tracking server that the user has failed to interact with the advertisement within a pre-determined time period.
